(19) United States
(12) Patent Application Publication
(10) Pub. No.: US 2026/0268327 A1
(43) Pub. Date: Sep. 10, 2026

(54) SERVICE PROCESSING METHOD

(71) Applicant: Tencent Technology (Shenzhen) Company Limited, Shenzhen (CN)

(72) Inventors: Jinkun HOU, Shenzhen (CN); Shuqin SUN, Shenzhen (CN); Bei YANG, Shenzhen (CN); Kai XIA, Shenzhen (CN); Jiayu HUANG, Shenzhen (CN); Wen GE, Shenzhen (CN); Bowen CHEN, Shenzhen (CN); Qinyan ZHANG, Shenzhen (CN); Hang ZHOU, Shenzhen (CN); Jinming ZHANG, Shenzhen (CN); Jun WANG, Shenzhen (CN); Zhiqiang ZHANG, Shenzhen (CN)

(73) Assignee: Tencent Technology (Shenzhen) Company Limited, Shenzhen (CN)

(21) Appl. No.: 19/657,155

(22) Filed: Apr. 24, 2026

Related U.S. Application Data
(63) Continuation of application No. PCT/CN2025/121584, filed on Sep. 16, 2025.

(30) Foreign Application Priority Data
Oct. 14, 2024 (CN) 202411440576.X

(51) Int. Cl. G06Q 20/40; G06Q 20/32

(52) U.S. Cl. CPC G06Q 20/40145; G06Q 20/326

(57) ABSTRACT

In a service processing method, first palm information for a palm-scan payment service is received based on a configuration operation of an object for the palm-scan payment service. In the method, account identification information of at least one electronic payment account associated with the object is displayed in a selection interface. In the method, a first selected electronic payment account from the at least one electronic payment account is determined based on a selection operation on the selection interface. In the method, the first selected electronic payment account is configured as a first configured electronic payment account associated with the first palm information for the palm-scan payment service, the palm-scan payment service being configured to process payment using the first configured electronic payment account when the palm-scan payment service is requested based on the first palm information.

### RELATED APPLICATIONS

The present application is a continuation of International Application No. PCT/CN2025/121584, filed on Sep. 16, 2025, which claims priority to Chinese Patent Application No. 202411440576.X, filed on Oct. 14, 2024. The entire disclosures of the prior applications are hereby incorporated by reference.

### FIELD OF THE TECHNOLOGY

This disclosure relates to the technical field of computers, including a service processing method and apparatus, a device, a computer-readable storage medium, and a computer program product.

### BACKGROUND OF THE DISCLOSURE

With the rapid development of computer technology and artificial intelligence technology, electronic payment has brought great convenience to people's lifestyles, and payment methods have become increasingly diversified. Currently, biometric feature recognition-based payment methods have achieved new progress: not only face-scan payment is supported, but also palm-scan payment has been developed. As a payment method with more emphasis on security and privacy, palm-scan payment is widely used in various payment scenes. Users may perform electronic payment using biometric feature recognition devices (such as palm-scan devices) in offline stores, enabling users who do not carry payment devices to complete payment conveniently, thereby enhancing payment convenience. However, in palm-scan payment services, configuration of a payment account requires users to rely on professional configuration devices and certain configuration platforms, which imposes significant limitations. This not only causes substantial waste of configuration resources for palm-scan payment services, but also results in inflexible and inconvenient payment in the palm-scan payment scenes.

In summary, how to expand more convenient configuration methods for palm-scan payment services in a resource-efficient manner and improve the configuration efficiency of the palm-scan payment services remains an unsolved technical challenge in the related art.

### SUMMARY

Embodiments of this disclosure provide a service processing method and apparatus, a device, a non-transitory computer-readable storage medium, and a computer program product, which may improve configuration efficiency of palm-scan payment services in palm-scan payment scenes.

The embodiments of this disclosure provide a service processing method. In the method, first palm information for a palm-scan payment service is received, by processing circuitry of a terminal device, based on a configuration operation of an object for the palm-scan payment service. In the method, account identification information of at least one electronic payment account associated with the object is displayed in a selection interface. In the method, a first selected electronic payment account from the at least one electronic payment account is determined based on a selection operation on the selection interface. In the method, the first selected electronic payment account is configured, by the processing circuitry, as a first configured electronic payment account associated with the first palm information for the palm-scan payment service, the palm-scan payment service being configured to process payment using the first configured electronic payment account when the palm-scan payment service is requested based on the first palm information.

The embodiments of this disclosure provide a service processing method. In the method, first palm information for the palm-scan payment service is received, by processing circuitry of a terminal device, based on a request operation for a palm-scan payment service. In the method, account identification information of a plurality of configured electronic payment accounts associated with the first palm information is displayed in a selection interface. In the method, a selected electronic payment account from the plurality of configured electronic payment accounts is determined, by the processing circuitry, based on a selection operation on the selection interface. In the method, payment using the selected electronic payment account is performed.

The embodiments of this disclosure provide a terminal device that includes processing circuitry. The processing circuitry is configured to receive first palm information for a palm-scan payment service based on a configuration operation of an object for the palm-scan payment service. The processing circuitry is configured to display, in a selection interface, account identification information of at least one electronic payment account associated with the object. The processing circuitry is configured to determine a first selected electronic payment account from the at least one electronic payment account based on a selection operation on the selection interface. The processing circuitry is configured to configure the first selected electronic payment account as a first configured electronic payment account associated with the first palm information for the palm-scan payment service, the palm-scan payment service being configured to process payment using the first configured electronic payment account when the palm-scan payment service is requested based on the first palm information.

The embodiments of this disclosure provide a terminal device that includes processing circuitry. The processing circuitry is configured to receive, based on a request operation for a palm-scan payment service, first palm information for the palm-scan payment service. The processing circuitry is configured to display, in a selection interface, account identification information of a plurality of configured electronic payment accounts associated with the first palm information. The processing circuitry is configured to determine a selected electronic payment account from the plurality of configured electronic payment accounts based on a selection operation on the selection interface. The processing circuitry is configured to perform payment using the selected electronic payment account.

The embodiments of this disclosure provide a non-transitory computer-readable storage medium storing instructions, which when executed by a processor, cause the processor to perform a service processing method. In the method, first palm information for a palm-scan payment service is received based on a configuration operation of an object for the palm-scan payment service. In the method, account identification information of at least one electronic payment account associated with the object is displayed in a selection interface. In the method, a first selected electronic payment account from the at least one electronic payment account is determined based on a selection operation on the selection interface. In the method, the first selected electronic payment account is configured as a first configured electronic payment account associated with the first palm information for the palm-scan payment service, the palm-scan payment service being configured to process payment using the first configured electronic payment account when the palm-scan payment service is requested based on the first palm information.

The embodiments of this disclosure provide a non-transitory computer-readable storage medium storing instructions, which when executed by a processor, cause the processor to perform a service processing method. In the method, first palm information for the palm-scan payment service is received based on a request operation for a palm-scan payment service. In the method, account identification information of a plurality of configured electronic payment accounts associated with the first palm information is displayed in a selection interface. In the method, a selected electronic payment account from the plurality of configured electronic payment accounts is determined based on a selection operation on the selection interface. In the method, payment using the selected electronic payment account is performed.

The embodiments of this disclosure provide a service processing method. The method is performed by a first terminal device, and includes: receiving, in response to a configuration operation of a first object for a palm-scan payment service, first palm information for the palm-scan payment service; displaying at least one electronic payment account of the first object; and configuring, in response to a selection operation on the at least one electronic payment account, a selected first electronic payment account as an electronic payment account associated with the first palm information, when the palm-scan payment service based on the first palm information is used, a configured first electronic payment account associated with the first palm information being adopted for payment.

The embodiments of this disclosure provide a service processing apparatus. The apparatus includes: a first transceiver unit, configured to receive, in response to a configuration operation of a first object for a palm-scan payment service, first palm information for the palm-scan payment service; a first display unit, configured to display at least one electronic payment account of the first object; and a configuration unit, configured to configure, in response to a selection operation on the at least one electronic payment account, a selected first electronic payment account as an electronic payment account associated with the first palm information, when the palm-scan payment service based on the first palm information is used, a configured first electronic payment account associated with the first palm information being adopted for payment.

The embodiments of this disclosure provide a first terminal device. The first terminal device includes: a memory, including a non-transitory computer-readable storage medium configured to store a computer-executable instruction or a computer program; and processing circuitry (e.g., a processor), configured to implement, when executing the computer-executable instruction or the computer program stored in the memory, the foregoing service processing method.

The embodiments of this disclosure provide a service processing method. The method is performed by a second terminal device, and includes: receiving, in response to a request operation for a palm-scan payment service, first palm information for the palm-scan payment service; displaying a configured first electronic payment account associated with the first palm information; and performing payment using the first electronic payment account.

The embodiments of this disclosure provide a service processing apparatus. The apparatus includes: a second transceiver unit, configured to receive, in response to a request operation for a palm-scan payment service, first palm information for the palm-scan payment service; a second display unit, configured to display a configured first electronic payment account associated with the first palm information; and a payment unit, configured to perform payment using the first electronic payment account.

The embodiments of this disclosure provide a second terminal device. The second terminal device includes: a memory, including a non-transitory computer-readable storage medium configured to store a computer-executable instruction or a computer program; and processing circuitry (e.g., a processor), configured to implement, when executing the computer-executable instruction or the computer program stored in the memory, the foregoing service processing method.

The embodiments of this disclosure provide a non-transitory computer-readable storage medium, having a computer-executable instruction or a computer program stored therein, the computer-executable instruction or the computer program, when loaded and executed by processing circuitry (e.g., a processor), implementing the foregoing service processing method.

The embodiments of this disclosure provide a computer program product, including a computer program or a computer-executable instruction, the computer program or the computer-executable instruction, when executed by processing circuitry (e.g., a processor), implementing the foregoing service processing method.

In the embodiments of this disclosure, the first electronic payment account is configured as the electronic payment account associated with the first palm information, so that the first electronic payment account may be configured for the palm-scan payment service. Therefore, in a use process of the palm-scan payment service, when the first palm information is received, the configured first electronic payment account associated with the first palm information is adopted for payment. According to the foregoing procedure, based on the configuration operation of the first object, the first object may configure one or more electronic payment accounts associated with the first palm information. These electronic payment accounts may be configured for the palm-scan payment service. Configuration of the electronic payment account is no longer limited to professional configuration devices or certain configuration platforms, nor is it limited to physical payment account types. Therefore, not only are configuration resources saved during the configuration of the palm-scan payment service, but also the diversity of payment accounts of the palm-scan payment service can be improved, and the configuration efficiency of the palm-scan payment service in the palm-scan payment scenes is further improved. In addition, after the palm-scan payment service is configured, palm-scan payment may be implemented in various payment scenes, and when the palm-scan payment service is used, only palm information of an object needs to be provided. Thus, an associated electronic payment account may be flexibly selected, thereby effectively improving the flexibility and convenience of payment in the palm-scan payment scenes.

### BRIEF DESCRIPTION OF THE DRAWINGS

To describe technical solutions in embodiments of this disclosure, the drawings in the descriptions of the embodiments will be briefly introduced below. The drawings in the following description are merely some embodiments of this disclosure, and a person skilled in the art may obtain other drawings according to these drawings.

FIG. 1 is an architectural diagram of a service processing system according to an embodiment of this disclosure.

FIG. 2 is a schematic flowchart of a service processing method according to an embodiment of this disclosure.

FIG. 3a is a schematic diagram of displaying a service startup interface according to an embodiment of this disclosure.

FIG. 3b is a schematic diagram of displaying an object identifier of a first object according to an embodiment of this disclosure.

FIG. 3c is a schematic diagram of displaying an account login interface according to an embodiment of this disclosure.

FIG. 3d is a schematic diagram of receiving first palm information according to an embodiment of this disclosure.

FIG. 3e is a schematic diagram of outputting a palm information enrollment invitation according to an embodiment of this disclosure.

FIG. 3f is a schematic diagram of displaying at least one electronic payment account of a first object according to an embodiment of this disclosure.

FIG. 3g is a schematic diagram of configuring an electronic payment account according to an embodiment of this disclosure.

FIG. 3h is a schematic diagram of outputting an account association invitation according to an embodiment of this disclosure.

FIG. 4 is a schematic flowchart of another service processing method according to an embodiment of this disclosure.

FIG. 5a is a schematic diagram of account authorization prompt information according to an embodiment of this disclosure.

FIG. 5b is a schematic diagram of displaying an identity verification interface according to an embodiment of this disclosure.

FIG. 5c is a schematic diagram of another account authorization prompt information according to an embodiment of this disclosure.

FIG. 5d is a schematic diagram of receiving identity verification information in an identity verification interface according to an embodiment of this disclosure.

FIG. 5e is a schematic diagram of setting a palm identifier according to an embodiment of this disclosure.

FIG. 5 f is a schematic diagram of displaying N pieces of palm information according to an embodiment of this disclosure.

FIG. 6 is a schematic flowchart of another service processing method according to an embodiment of this disclosure.

FIG. 7a is a schematic diagram of adding a second electronic payment account according to an embodiment of this disclosure.

FIG. 7 b is a schematic diagram of displaying M electronic payment accounts according to an embodiment of this disclosure.

FIG. 7c is a schematic diagram of deleting an electronic payment account according to an embodiment of this disclosure.

FIG. 7d is a schematic diagram of setting a payment priority of an electronic payment account according to an embodiment of this disclosure.

FIG. 7e is a schematic diagram of setting a payment limit of an electronic payment account according to an embodiment of this disclosure.

FIG. 7f is a schematic diagram of setting payment permission of an electronic payment account according to an embodiment of this disclosure.

FIG. 7g is a schematic diagram of displaying a bill for an electronic payment account according to an embodiment of this disclosure.

FIG. 7h is a schematic diagram of a configuration procedure of a palm-scan payment service according to an embodiment of this disclosure.

FIG. 8a is a schematic diagram of a configuration procedure of another palm-scan payment service according to an embodiment of this disclosure.

FIG. 8b is a schematic flowchart of enrolling a palm image according to an embodiment of this disclosure.

FIG. 8c is a schematic flowchart of associating an electronic payment account according to an embodiment of this disclosure.

FIG. 8d is a schematic flowchart of associating an object identifier of a first object according to an embodiment of this disclosure.

FIG. 9 is a schematic flowchart of yet another service processing method according to an embodiment of this disclosure.

FIG. 10a is a schematic diagram of receiving first palm information for a palm-scan payment service according to an embodiment of this disclosure.

FIG. 10b is a schematic diagram of displaying a configured electronic payment account according to an embodiment of this disclosure.

FIG. 10c is a schematic diagram of displaying an auxiliary verification interface according to an embodiment of this disclosure.

FIG. 10d is a schematic diagram of outputting a payment result according to an embodiment of this disclosure.

FIG. 10e is a schematic diagram of a use procedure of a palm-scan payment service according to an embodiment of this disclosure.

FIG. 11a is a flowchart of offline palm-scan payment according to an embodiment of this disclosure.

FIG. 11b is a schematic flowchart of retrieval and recognition according to an embodiment of this disclosure.

FIG. 11c is a schematic flowchart of returning a control code for verification according to an embodiment of this disclosure.

FIG. 12a is a schematic structural diagram of a service processing apparatus according to an embodiment of this disclosure.

FIG. 12b is a schematic structural diagram of another service processing apparatus according to an embodiment of this disclosure.

FIG. 13 is a schematic structural diagram of a terminal device according to an embodiment of this disclosure.

### DESCRIPTION OF EMBODIMENTS

Embodiments of this disclosure will be described below with reference to accompanying drawings of this disclosure. The described embodiments are merely some rather than all of the embodiments of this disclosure. All other embodiments obtained by a person skilled in the art based on the embodiments of this disclosure fall within the scope of this disclosure. Other embodiments are within the scope of this disclosure.

To understand the technical solutions provided in the embodiments of this disclosure, key terms related to the embodiments of this disclosure are introduced herein. Descriptions of terms in this disclosure are provided as examples only and are not intended to limit the scope of this disclosure.
(1) Palm information: it may correspond to image data related to a user's palm collected through a biometric feature recognition technology, including but not limited to palm print images and palm vein images. These images may be usable in user identity recognition and usable as a basis for payment verification.
(2) Palm-scan payment service: it may correspond a payment service based on palm information instead of payment passwords, and may be a cardless payment method in which a user completes payment by placing a palm on a recognition device without carrying a mobile phone or a bank card after a palm print or palm vein image (collectively referred to as palm information) of the user has been collected and bound with an electronic payment account of the user. In some embodiments of this disclosure, the palm-scan payment service may include a configuration process and a use process. In some examples, for an object (for example, a user), the palm-scan payment service may be first configured and then used. The configuration process mainly includes enrolling palm information and associating an electronic payment account, and the use process includes performing payment using a corresponding electronic payment account based on the palm information enrolled during the configuration process. The configuration process and the use process may be performed in different terminal devices, for example, configuration on a mobile phone and use on a palm-scan device. The use process of the palm-scan payment service may be referred to as palm-scan payment for short. In the palm-scan payment process, identity recognition may be performed on a payment object using a palm recognition technology. The palm recognition technology may be based on a biometric feature recognition technology that involves performing identity recognition based on one or two of a palm print and a palm vein in a palm. The palm print recognition technology achieves identity recognition by recognizing a palm image from the fingertips to the wrist. The vein recognition technology achieves identity recognition by identifying and analyzing patterns of veins. In the vein recognition technology, harmless infrared light irradiates the living body. The infrared light penetrates the epidermis and reaches blood vessels, where it is absorbed by hemoglobin in the veins to form a vascular image. Feature comparison and matching are performed on the vascular image and a reference image in a database, thereby achieving identity authentication and recognition. In the configuration process of the palm-scan payment service, a professional palm-scan device may be adopted to collect palm prints and palm veins as two-factor features, so that during palm-scan payment, an identity of an object can be accurately recognized by reading the palm prints and the palm veins, thereby achieving double guarantee of security.
(3) Payment account: it may correspond to an account that is usable to perform services such as digital asset transfer (including receipt, payment, and fund transfer) and payment and settlement. A payment account may be established by a bank or another payment service provider (such as a payment institution or a third-party payment platform), exist in a digital form, and associated with the identity of the object. According to an account form, the payment account may include a bank account (a savings account, or the like), an electronic payment account, and a dedicated account (an account for a designated purpose, such as a pension account). The electronic payment account may correspond to an account for the receipt and transfer of digital assets using the Internet. The electronic payment account may correspond to a virtual account that does not have a physical form, and may not be directly associated with a bank account. The electronic payment account may be provided by a third-party payment service provider, or may be a part of an online service provided by a bank. The electronic payment account may enable online transactions, such as shopping, fund transfer, and bill payment, without physical asset exchange, and can provide convenient mobile payment services.
(4) First terminal device: it may correspond to a computing device or an intelligent device used by a user, such as a smartphone or a tablet computer, and may be configured to enroll palm information, configure an electronic payment account, and manage related settings of the palm-scan payment service.
(5) Second terminal device: it may correspond to a palm-scan recognition terminal deployed by an offline merchant, and may be configured to read palm information during payment of the user and invoke a bound electronic payment account to complete transaction deduction.
(6) Device-based palm scanning: it may correspond to a process of performing fingerprint recognition or palm print recognition on a device. The technology is often used for security verification, such as mobile phone unlocking and payment authentication. By scanning the palm print of an object (such as a user), the device may confirm the identity, thereby improving the security. As a non-limiting example, an operation may include placing a palm on a sensor, capturing and analyzing palm print features by a system, and determining the identity of the object based on comparison of the palm print features with those in a feature library.
(7) Payment: it may correspond to a process of deducting a corresponding amount from a bound electronic payment account according to recognized user identity information to complete a payment behavior.

Based on the introduction of the foregoing terms as non-limiting examples, the embodiments of this disclosure provide a service processing method and apparatus, a device, a non-transitory computer-readable storage medium, and a computer program product. The first terminal device in the service processing method may receive, in response to a configuration operation of a first object for a palm-scan payment service, first palm information for the palm-scan payment service. Next, at least one electronic payment account of the first object is displayed. An owner of each electronic payment account is the first object. Then, in response to a selection operation on the at least one electronic payment account, a selected first electronic payment account is configured as an electronic payment account associated with the first palm information. In this way, the first electronic payment account may be configured for the palm-scan payment service. Therefore, in the use process of the palm-scan payment service, when the first palm information is received, the configured first electronic payment account associated with the first palm information is adopted for payment. According to the foregoing procedure, based on the configuration operation of the first object, the first object may configure one or more electronic payment accounts associated with the first palm information. These electronic payment accounts may be configured for the palm-scan payment service. According to one or more embodiments of this disclosure, configuration of the electronic payment account is not limited to physical payment account types, and the diversity of payment accounts for the palm-scan payment service can be improved. In addition, the palm-scan payment service supports the integration of various payment instruments (that is, not only physical payment accounts such as bank accounts, but also electronic payment accounts), expanding payment channels. In addition, if a plurality of electronic payment accounts is configured, when the palm-scan payment service is used, only palm information of the object needs to be provided, so that an associated electronic payment account may be flexibly selected, thereby effectively improving the flexibility and convenience of payment in the palm-scan payment scene.

In the embodiments of this disclosure, the term “at least one” refers to one or more, and “a plurality of” refers to two or more. For example, at least one electronic payment account refers to one, two, or more electronic payment accounts. The terms such as “first” and “second” are intended to distinguish same items or similar items with substantially same effects and functions. The “first”, “second”, and “n^{th}” do not have a dependency relationship in logic or time sequence, and a quantity and an execution order are not limited.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

In the embodiments of this disclosure, the term “module” or “unit” refers to a computer program having a predetermined function or a part of the computer program, operates together with other relevant parts to achieve a predetermined objective, and may be all or partially implemented through software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (for example, computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

Hereinafter, an architecture of a service processing system according to an embodiment of this disclosure will be described as a non-limiting example with reference to the accompanying drawings.

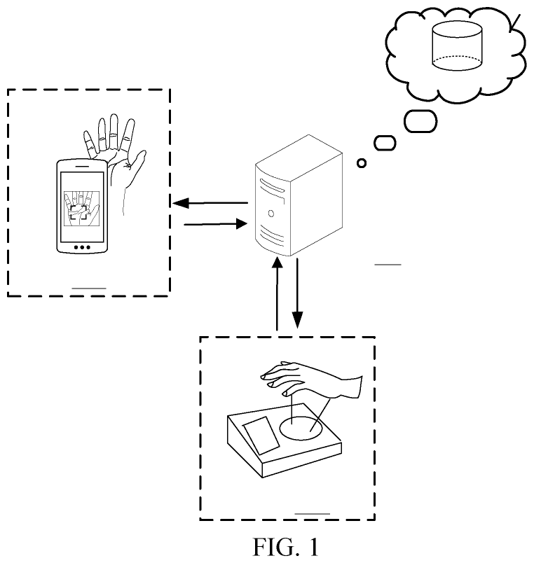

FIG. 1 is an architectural diagram of a service processing system according to an embodiment of this disclosure. As shown in FIG. 1, the service processing system includes at least one terminal device (including a first terminal device 101a and a second terminal device 101b), a server 102, and a database 103. Each terminal device may establish a communication connection to the server 102 in a wired or wireless manner, and the database 103 establishes a communication connection to the server 102 in a wired or wireless manner.

The terminal device includes, but is not limited to, a smartphone, a tablet computer, an intelligent wearable device, an intelligent speech interaction device, an intelligent appliance, a personal computer, an in-vehicle terminal, an intelligent camera, and other devices. This is not limited in this disclosure. A quantity of terminal devices is not limited in this disclosure. The server 102 may be an independent physical server, may be a server cluster or a distributed system including a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform, but is not limited thereto. A quantity of servers is not limited in this disclosure. According to deployment positions, the database 103 may be a local database of the server 102, or may be a cloud database that can establish a connection to the server 102. According to attributes, the database 103 may be a public database, that is, a database open to all computer devices, or may be a private database, that is, a database open only to a server (such as the server 102). The database 103 may be configured to classify and store palm information collected by different terminal devices. For example, palm information collected by a first terminal device and palm information collected by a second terminal device may be classified and stored. As a feature, the palm information may be configured for comparison to determine an identity of an object.

Descriptions are provided below using an example in which the terminal device includes a first terminal device 101a and a second terminal device 101b, the first terminal device 101a is configured to perform a configuration procedure of a palm-scan payment service, and the second terminal device 101b is configured to perform a use procedure of the palm-scan payment service. As a non-limiting example, a procedure of the service processing method performed by the first terminal device 101a is described as follows. First, the first terminal device 101a receives, in response to a configuration operation of a first object for the palm-scan payment service, first palm information for the palm-scan payment service. In at least one example, if the first object starts the palm-scan payment service, the first terminal device 101a may collect a palm image, so as to receive the first palm information for the palm-scan payment service. For example, the first palm information is palm information of the first object. Then, the first terminal device 101a displays at least one electronic payment account of the first object. For example, one electronic payment account of the first object may be displayed, or a plurality of electronic payment accounts may be displayed. An owner of each electronic payment account is the first object. If a plurality of electronic payment accounts are displayed, different electronic payment accounts may be electronic payment accounts provided by different payment platforms. For example, if the palm-scan payment service is provided by a first application (APP), the displayed payment platform corresponding to each electronic payment account is a payment platform allowed to access the first APP. Finally, the first terminal device 101a configures, in response to a selection operation on the at least one electronic payment account, a selected first electronic payment account as an electronic payment account associated with the first palm information. In at least one example, if the first object selects one electronic payment account from the at least one electronic payment account (for example, two electronic payment accounts), the selected electronic payment account is the first electronic payment account, and may be configured as the electronic payment account associated with the first palm information.

In some embodiments, after the first palm information is received by the first terminal device, if the object skips the operation of configuring the first electronic payment account (for example, in the operation of configuring the electronic payment account, the option of “decide later” is selected) or the first electronic payment account associated with the first palm information is configured, the electronic payment account associated with the first palm information may still be configured. For example, the first terminal device may trigger, in response to an addition operation on the electronic payment account, to perform the operation of displaying at least one electronic payment account of the first object, to configure the electronic payment account associated with the palm information for the palm-scan payment service. The first palm information is associated with one or more electronic payment accounts.

In some embodiments, if the first palm information has already been associated with the first electronic payment account, the first terminal device may still receive, in response to an addition operation on the palm information, second palm information for the palm-scan payment service. Based on the addition of the second palm information, the first terminal device may automatically associate the second palm information with the existing first electronic payment account. The first electronic payment account supports association with one or more pieces of palm information.

As a non-limiting example, a process of the service processing method performed by the second terminal device 101b is described as follows. First, the second terminal device 101b receives, in response to a request operation for the palm-scan payment service, first palm information for the palm-scan payment service. Then, the second terminal device 101b displays a configured first electronic payment account associated with the first palm information. An owner of the first electronic payment account is the first object. Finally, the second terminal device 101b performs payment using the first electronic payment account. It can be seen that, in the palm-scan payment scene, based on receiving the first palm information, the second terminal device may perform payment using a configured associated electronic payment account. In some embodiments, if the first palm information is further associated with a second electronic payment account, the object may select one of the electronic payment accounts for payment, thereby improving payment flexibility. For example, when a payment limit of a payment account is insufficient, another electronic payment account may be reselected for payment.

According to one or more embodiments of this disclosure, the first terminal device may perform the configuration procedure of the palm-scan payment service. The first terminal device may receive, in response to the configuration operation for the palm-scan payment service, the first palm information for the palm-scan payment service, display the at least one electronic payment account of the first object, and then configure, in response to selection of any one of the at least one electronic payment account, the selected first electronic payment account as the electronic payment account associated with the first palm information. Through the configuration of the palm-scan payment service, one or more electronic payment accounts may be associated with the first palm information that may be used for the palm-scan payment service. In the use procedure of the palm-scan payment service, the second terminal device may receive the first palm information in response to the request operation for the palm-scan payment service, and perform payment using the first electronic payment account associated with the first palm information. Based on the association between the first palm information and the electronic payment account, more payment methods are supported during palm-scan payment, thereby improving the payment convenience and flexibility.

The service processing method provided in the embodiments of this disclosure will be described below.

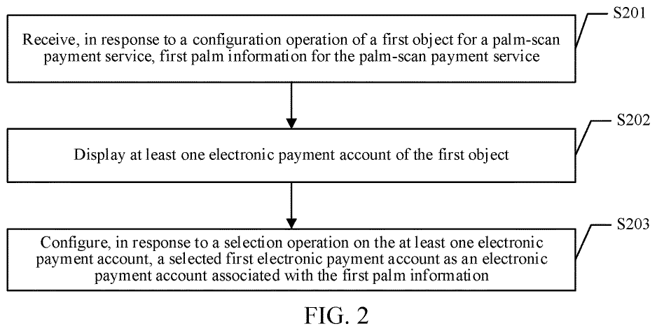

FIG. 2 is a schematic flowchart of a service processing method according to an embodiment of this disclosure. The service processing method may be performed by a first terminal device (for example, the first terminal device 101a shown in FIG. 1). The service processing method may include the following operation S201 to operation S203.

S201: Receive, in response to a configuration operation of a first object for a palm-scan payment service, first palm information for the palm-scan payment service. For example, first palm information for a palm-scan payment service is retrieved, by processing circuitry of a terminal device, based on a configuration operation of an object (e.g., a user of the terminal device) for the palm-scan payment service.

Herein, the first object may refer to the user, that is, the user enters a service configuration interface of the palm-scan payment service through the first terminal device (such as a mobile phone) of the user, and actively initiates a configuration request. In this case, the palm-scan payment system (which may be the foregoing service processing system) may direct the first object to complete an operation of palm recognition. The palm-scan payment service is a cardless payment method based on a biometric feature recognition technology. The first object does not need to carry a mobile phone or a bank card and can complete a payment operation using only the palm.

The first palm information includes palm information of the first object. The palm information may include a palm print image and a palm vein image. These pieces of data are used as a basis for identity verification on the first object. In some embodiments, the palm information of the first object may be collected through the first terminal device. To enhance the collection quality, a dedicated living body detection sensor may be built in the first terminal device, to prevent deceptive enrollment using a false hand or another non-living hand model.

The first terminal device may display the service configuration interface for the palm-scan payment service in response to a start operation for the palm-scan payment service; then, display collection guidance information in response to login information received in the service configuration interface, the collection guidance information being configured for guiding the first object to collect palm information; and collect the palm information of the first object in response to a collection operation performed by the first object. The configuration operation of the first object for the palm-scan payment service may include the collection operation. That is, the first terminal device may further prompt the first object to place the palm according to a specified posture, to enhance the completeness and consistency of the image. During an actual implementation, the first object may start a palm enrollment procedure through a mini program of an instant messaging APP, or the like. The first terminal device guides the first object to place the palm on a camera or a dedicated sensor of the first terminal device, and the first terminal device completes living body detection and collects a multi-angle palm image. The multi-angle palm image collected through the mini program will be encrypted and stored, and bound to the identity information of the first object, to provide a reliable identity verification basis for a subsequent palm-scan payment service.

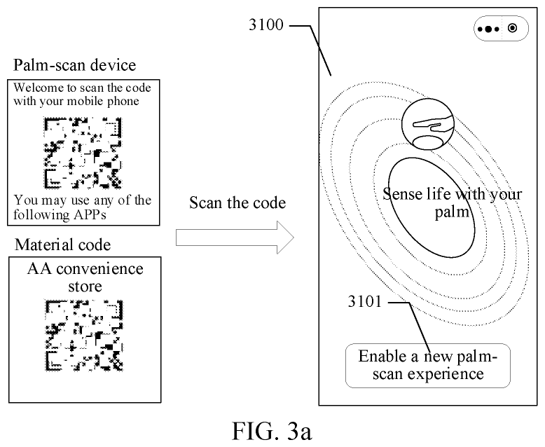

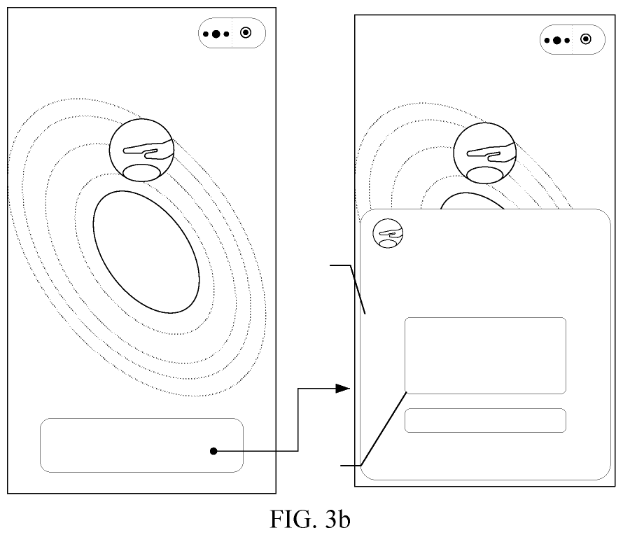

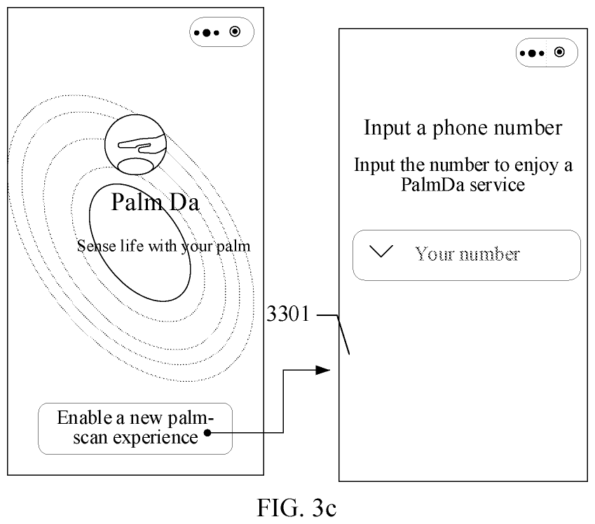

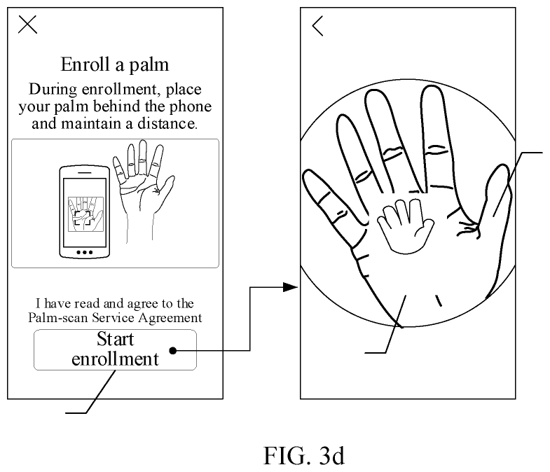

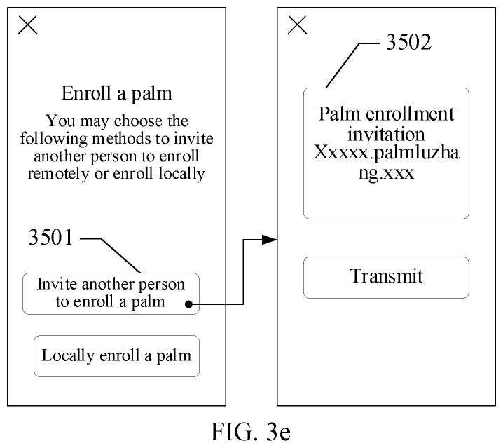

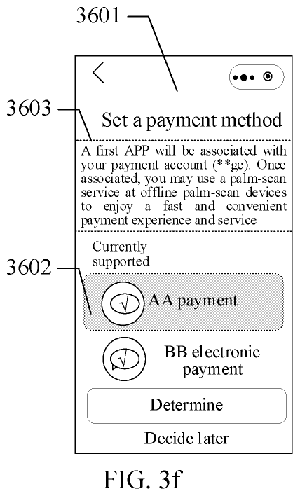

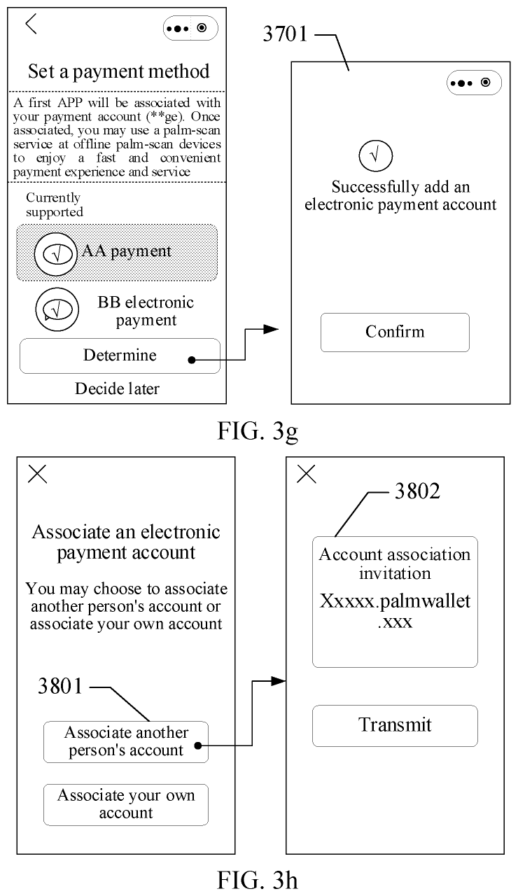

The start operation may be a trigger operation for displaying a start control in the service startup interface. The palm-scan payment service is provided by the first APP. The first APP may be a mini program or a third-party APP. The first APP is a software service product that provides palm information enrollment and palm-scan use management, and is configured to provide the palm-scan payment service. The service startup interface may be provided by the first APP. The first terminal device may display the service startup interface in response to a scanning operation on a graphic code of the first APP. FIG. 3a is a schematic diagram of displaying a service startup interface. The first terminal device may scan a material code of an offline store or a graphic code of a palm-scan device, thereby displaying a service startup interface 3100. A start control 3101 is displayed in the service startup interface, and text content of the start control 3101 is: Enable a new palm-scan experience. Alternatively, the first terminal device may display the service startup interface directly in response to a start operation on the first APP (for example, searching for and launching a mini program (a mini program is an installation-free APP), or launching an APP from a mobile phone desktop).

After the start control in the service startup interface is triggered, the service configuration interface may be displayed, and an object identifier of the first object is displayed in the service configuration interface. If the first object does not register an account in the first APP, and the first APP is associated with a second APP, for example, the first APP is a mini program embedded in the second APP, the first terminal device may display an object identifier (such as a mobile phone number) associated with the second APP. FIG. 3b is a schematic diagram of displaying an object identifier of a first object. After the start control is clicked, a service configuration interface 3201 may be displayed. The service configuration interface 3201 is floatingly displayed on the service startup interface, and an object identifier 3202 of the first object is displayed in the service configuration interface. The displayed object identifiers include two mobile phone numbers. Any mobile phone number is selected, and the selected mobile phone number may be configured for online account registration in the first APP, thereby performing subsequent procedures such as palm enrollment and electronic payment account association. If the object selects “not allowed” or “use another identifier”, an account login interface may be displayed, and a mobile phone number is inputted in the account login interface. If the first object has registered an account in the first APP, after the start control in the service startup interface is triggered, the displayed service configuration interface is the account login interface, and the account login interface includes to-be-inputted login information. In some examples, as shown in FIG. 3c, an account login interface 3301 may be displayed by clicking a start button in the service startup interface. The account login interface 3301 includes a to-be-inputted account number, for example, a phone number. If the first object does not enroll palm information, the first terminal device may display an information collection interface in response to login information (such as a phone number) inputted in the account login interface.

The collection guidance information may be displayed in the information collection interface. The information collection interface is an interface independent of the service configuration interface. Alternatively, the collection guidance information is displayed in a message pop-up window, and the message pop-up window is floatingly displayed on the service configuration interface. The collection operation may include, but is not limited to, a trigger operation (such as clicking) on a collection control in the information collection interface, a gesture operation (such as double-clicking or long-pressing) performed in the information collection interface, and a selection operation on a confirmation control in the message pop-up window. Based on execution of the collection operation, the first terminal device may receive the first palm information for the palm-scan payment service.

In some embodiments, in response to the collection operation performed by the first object, the first terminal device may first display interaction prompt information. The interaction prompt information is configured for prompting the first object to adjust a palm position and a palm action. The first terminal device may display a palm image of a corresponding action performed by the first object. The collected palm image corresponding to each of one or more actions may be used as the first palm information. The collection of the first palm information is a dynamic process, and the interaction prompt information displayed in the first terminal device may dynamically change. For example, the first object may be sequentially prompted to perform an action 1 (for example, opening the palm), an action 2 (making a fist), and an action 3 (another fixed gesture action), and images corresponding to the foregoing actions are sequentially collected. FIG. 3d is a schematic diagram of receiving first palm information. Based on triggering of a collection control 3401 of “start enrollment” in the information collection interface, interaction prompt information 3402 may be outputted, and text content thereof is: “Please make a fist”. A palm image 3403 captured by a camera of a mobile phone may further be displayed, and the object may adjust the palm action (for example, making a fist) according to the interaction prompt information.

The first terminal device may invoke a photographing module to capture a first palm image (for example, a left palm image), and determine the first palm image as the first palm information. The first terminal device may collect the first palm information independently, or a device (for example, a camera connected to a computer) connected to the first terminal device collects the first palm information and then transmits the first palm information to the first terminal device. The first palm information may be the palm information of the first object, or may be palm information of another object that is allowed to be added by the first object, for example, a right palm image of a second object.

In an implementation, the first palm information may include palm information of the second object, the first terminal device is a terminal device of the first object, and the first terminal device may output a palm information enrollment invitation in response to the configuration operation of the first object for the palm-scan payment service. The palm information enrollment invitation includes one or more of the following forms: a text link, a graphic code, and the like. The graphic code is an information encoding product. The graphic code encodes information through a particular pattern, color, or shape. For example, the graphic code is a two-dimensional code, a bar code, or the like. In some examples, as shown in FIG. 3e, a control 3501 of “invite another person to enroll a palm” is clicked, and a text link 3502 of the palm information enrollment invitation may be displayed. The first terminal device transmits the palm information enrollment invitation to the second object. The first APP provides the palm-scan payment service, the second object may be an object of the second APP, and the second APP allows access to the first APP. The palm information enrollment invitation may be transmitted to the second object in the form of a session message, a mail, or the like. A terminal device of the second object may receive the palm information enrollment invitation, remotely enroll the palm information of the second object in response to triggering of the palm information enrollment invitation (for example, scanning a graphic code or clicking a text link), and directly return the palm information to the first terminal device, or return a graphic code storing the palm information to the first terminal device. The first terminal device may receive the palm information of the second object. In this manner, even if the second object and the first object are located in different places, based on transmitting of the palm information enrollment invitation, the palm information of the second object can be conveniently acquired, thereby resolving a problem that palm information of another person is restricted due to the fact that an object whose palm information is enrolled and an object that performs the configuration operation are located in different regions.

In another implementation, the first palm information includes palm information acquired by recognizing a palm information storage medium. The first terminal device may acquire the palm information storage medium in response to the configuration operation of the first object for the palm-scan payment service. The palm information storage medium has palm information stored therein, and the stored palm information belongs to the first object or the second object. The palm information storage medium includes, but is not limited to, a graphic code, a text, a numerical value, an audio, and the like. In some examples, before configuring the palm-scan payment service, the first terminal device may receive the graphic code transmitted by the terminal device of the second object and locally store the graphic code. The graphic code has the palm information of the second object stored therein. The second object may actively enroll the palm information and generate the graphic code in the terminal device, and transmit the graphic code to the first terminal device in a corresponding manner (for example, a session message, a short message, Bluetooth, or short-distance communication (for example, “tap-to-connect” communication between terminal devices)). When configuring the palm-scan payment service, the first terminal device may directly acquire, in response to the configuration operation, the graphic code from local storage space of the first terminal device. The first terminal device may recognize the palm information storage medium, to obtain the palm information stored in the palm information storage medium. For example, in response to a scanning operation on the graphic code, the first terminal device recognizes the graphic code and receives the palm information stored by the graphic code. In this manner, the enrollment of the palm information no longer requires real-time collection of palm images. Instead, the palm information may be stored in a corresponding form (such as a graphic code) in advance, and the first terminal device may conveniently and efficiently receive the palm information.

S202: Display at least one electronic payment account of the first object. For example, account identification information of at least one electronic payment account associated with the object is displayed in a selection interface.

In some examples, the account identification information is obtained from first account information of first one or more accounts registered as being associated with an object identifier of the first object, or second account information of second one or more accounts received by the terminal device based on a user input operation, or both. In an implementation, an owner of each electronic payment account is the first object. An implementation in which the first terminal device displays the at least one electronic payment account of the first object includes any one or more of the following manners.

Manner 1: Acquire an object identifier of the first object, and display at least one electronic payment account corresponding to the object identifier of the first object. The object identifier of the first object includes, but is not limited to: a communication identification code (for example, a mobile phone number) of the first object, and an object identifier (for example, a user identification (ID)) of the first object in an APP providing electronic payment accounts. The first terminal device may acquire the object identifier of the first object based on an authorization operation for the object identifier. For example, when a mobile phone number is authorized to log in to a mini program configured to provide a palm-scan payment service, an authorized mobile phone number may be acquired as the object identifier. Alternatively, the first terminal device may receive an input operation of the first object for the object identifier, and acquire the inputted object identifier as the object identifier of the first object. For example, a mobile phone number inputted by the first object in the account login interface may be used as the object identifier of the first object.

Each electronic payment account of the first object corresponds to the object identifier of the first object. Correspondence herein refers to binding between the electronic payment account and the object identifier. One object identifier may correspond to one or more electronic payment accounts. For example, a mobile phone number of an object may be bound to three electronic payment accounts, so that at least one electronic payment account may be determined based on the object identifier and then displayed. In this manner, the first terminal device may automatically acquire the object identifier of the first object, and accurately and quickly determine the electronic payment account based on the correspondence between the object identifier and the electronic payment account.

Manner 2: Receive at least one piece of account information inputted by the first object, and display an electronic payment account indicated by each piece of account information. The account information may include one or more of the following: an account number of the electronic payment account, an account name of the electronic payment account, and an owner of the electronic payment account. Each piece of account information may be configured for indicating one electronic payment account, and electronic payment accounts indicated by different pieces of account information are different. The first terminal device may display the electronic payment account indicated by each piece of account information. In this manner, the electronic payment account may be flexibly selected for display based on the account information inputted by the first object, rather than being fixed to display the electronic payment account corresponding to the object identifier. In this way, the flexibility of association of the electronic payment account may be improved.

In operation S202, the first terminal device may acquire all available electronic payment accounts of the first object from an authorized third-party payment platform, and present these electronic payment accounts in an interface of the first terminal device. The electronic payment account herein refers to an account established by the first object on a third-party payment platform such as a payment APP or a shopping APP. These accounts support online and offline payment operations. Since the first object may have a plurality of payment accounts, the first terminal device needs to list all selectable accounts for the first object to select as needed. When these electronic payment accounts are presented, presented information may include content such as an account name, a balance, and whether the account is authenticated using a real name. The first object may browse and select an account by clicking or sliding. During an actual implementation, the first terminal device may invoke an application programming interface (API) of a payment platform, acquire all associated electronic payment accounts of an account currently logged into by the first object, and present the associated electronic payment accounts in the interface in a list form. The manner of invoking the API of the payment platform and presenting the associated electronic payment accounts not only improves the convenience of the operation of the first object, but also improves the compatibility and expansibility of the system.

In some embodiments, the at least one electronic payment account of the first object may be displayed in a payment account configuration interface. In at least one example, the first terminal device may display the payment account configuration interface, and the at least one electronic payment account of the first object is displayed in the payment account configuration interface. These electronic payment accounts are not configured as electronic payment accounts used by the palm-scan payment service, that is, are not configured for the palm-scan payment service for the account of the first object.

The palm-scan payment service is provided by the first APP, each electronic payment account corresponds to one payment method (or payment channel), and each payment method is a payment method that the first APP allows to access. When an electronic payment account is displayed, a payment method corresponding to each electronic payment account may be displayed. Based on selection of a corresponding payment method, an electronic payment account of the first object corresponding to the selected payment method is displayed. For example, account information of the electronic payment account may be displayed. In some examples, as shown in FIG. 3f, at least one electronic payment account of the first object is displayed. In a payment account setting interface 3601, multiple currently supported payment methods may be displayed, for example, AA payment and BB electronic payment. Each payment method may correspond to one electronic payment account. For example, after AA payment identified by a payment method 3602 is selected, account information 3603 of a corresponding electronic payment account may be displayed in the payment account setting interface. For example, the following text content may be displayed: “The first APP will be associated with your payment account (**ge). Once associated, you may use the palm-scan service at offline palm-scan devices to enjoy a fast and convenient payment experience and service”.

S203: Configure, in response to a selection operation on the at least one electronic payment account, a selected first electronic payment account as an electronic payment account associated with the first palm information. For example, a first selected electronic payment account from the at least one electronic payment account is determined based on a selection operation on the selection interface. Also, the first selected electronic payment account is configured, by the processing circuitry, as a first configured electronic payment account associated with the first palm information for the palm-scan payment service. In some examples, the palm-scan payment service is configured to process payment using the first configured electronic payment account when the palm-scan payment service is requested based on the first palm information.

In an implementation, the selection operation on the at least one electronic payment account may be used for selecting an electronic payment account from the at least one electronic payment account, and the selected electronic payment account may be referred to as the first electronic payment account. The selection operation includes, but is not limited to, a click operation on any electronic payment account, a selection operation on any electronic payment account, a preset gesture operation, or an operation on a physical key (for example, operations on up and down keys in a physical keyboard).

During configuration, identity verification may be performed on the first electronic payment account by a payment service provider to which the first electronic payment account belongs. For example, if the first electronic payment account is provided by the second APP, identity verification may be performed by a backend service of the second APP. The identity verification is to verify whether the object currently performing the configuration operation is indeed the owner of the first electronic payment account (that is, the first object), rather than another object, to enhance the security of association of the electronic payment account. The identity verification may be implemented based on interaction information inputted by the first object after an electronic payment account is selected, or may be directly implemented by a backend without other interaction operations performed by the first object. When the identity verification succeeds, an association relationship may be established between the first electronic payment account and the first palm information. After the configuration succeeds, the first terminal device may further output a configuration success result. The configuration success result is configured for indicating the association between the first electronic payment account and the first palm information. FIG. 3g is a schematic diagram of configuring a first electronic payment account. After the first electronic payment account is selected for association, a configuration success result may be outputted. The configuration success result is displayed in an independent result interface 3701.

In some embodiments, based on the association relationship between the first electronic payment account and the first palm information, when the palm-scan payment service is used based on the first palm information, the configured first electronic payment account associated with the first palm information may be adopted for payment. For example, during palm-scan payment of the first object, if the first palm information is collected, payment may be performed through the first electronic payment account. That is, a corresponding amount of digital asset is transferred out from the first electronic payment account, and the asset amount of the first electronic payment account is updated. That is, in some embodiments, the first object selects an account from the electronic payment accounts presented by the first terminal device as an account to which the previously collected first palm information is bound. This binding relationship means that when the first object uses a palm-scan payment service in future offline consumption, the bound first electronic payment account is automatically invoked to complete a deduction operation. Payment refers to a process of deducting a corresponding amount from the bound first electronic payment account according to recognized first object identity information to complete a payment behavior. Communication with the payment platform is involved in the process of deducting a corresponding amount from the bound first electronic payment account according to the recognized first object identity information to complete the payment behavior, including links such as transmitting a transaction request, and receiving and feeding back a transaction result. In addition, the first terminal device may further support the first object to modify or replace a bound account. For example, the first object may reselect another account on the first terminal device for binding, and may further set a payment limit, close palm-scan payment service permission of some accounts, or the like.

During an actual implementation, after the first object selects an account, the first terminal device binds the unique identifier of the selected first electronic payment account to the palm information of the first object, and uploads the binding relationship to a backend server of the palm-scan payment service for storage. When the first object subsequently performs the offline palm-scan payment service, the second terminal device (for example, a palm-scan recognition terminal deployed by a merchant) reads the palm information of the first object, queries an electronic payment account corresponding to the palm information through a backend system, and completes a payment operation. In the entire process, the first object does not need to carry a mobile phone, thereby greatly improving the convenience and efficiency of payment.

According to one or more embodiments of this disclosure, collection of the palm information of the first object and the binding operation of the electronic payment account are completed on the first terminal device, so that the first object completes payment without a card or a mobile phone. In some embodiments, the first object enrolls the first palm information on the first terminal device, and selects an operation of binding to the first electronic payment account. Then, at any merchant on which a palm-scan device is disposed, the first object may complete the palm-scan payment service only by placing the palm on the recognition terminal. According to one or more embodiments of this disclosure, a service processing method not only simplifies the payment procedure and improves the payment efficiency, but also enhances the payment security because each payment relies on the unique biometric features of the first object for verification, making it difficult to be replicated or forged.

In some embodiments, when configuring the electronic payment account for the palm-scan payment service, the first terminal device may further output an account association invitation in response to an account invitation operation, and transmit the account association invitation for the electronic payment account to the second object. The account invitation operation includes, but is not limited to, a preset gesture operation, a trigger operation on an invitation control, and the like. The invitation control may be provided in an interface configured for displaying the electronic payment account of the first object, or may be provided in an association way selection interface. The association way selection interface includes a first association way and a second association way, and the account invitation operation includes selecting the second association way. The first association way is selected, and displaying of the electronic payment account of the first object may be triggered. The account association invitation is configured for inviting the electronic payment account of the second object to be associated with the first palm information. The first APP provides the palm-scan payment service, the second object may be an object of the second APP, and the second APP allows access to the first APP. When the second object agrees to the invitation, the second object may return an electronic payment account that is allowed to be associated, so that the first terminal device may associate the invited electronic payment account of the second object with the first palm information. In some examples, as shown in FIG. 3h, after a control 3801 for associating another person's account is clicked, an account association invitation 3802 may be presented, and then transmitted to the second object. The selection of the second object may occur before the account association invitation is outputted or after the account association invitation is outputted. For example, after the account association invitation is outputted, an object list may be displayed by clicking “transmit”. The object list includes a plurality of objects in the second APP for selection, and any selected object may be used as the second object.

In addition, the first terminal device may further receive an account association invitation transmitted by the terminal device of the second object. The account association invitation is configured for inviting the electronic payment account of the first object to be associated with the palm information of the second object. The first terminal device may transmit the electronic payment account of the first object to the terminal device of the second object in response to the account association invitation, so that the electronic payment account of the first object may be configured as an electronic payment account associated with the palm information of the second object, that is, an electronic payment account for the palm-scan payment service of the second object.

In the foregoing embodiment, the configuration of the electronic payment account for the palm-scan payment service is not limited to the selection of the displayed electronic payment account. Instead, the electronic payment account associated with another object may be actively invited, or the electronic payment account of the object may be added to the palm-scan payment service configured by another object. In this way, when the palm-scan payment service is configured, the electronic payment account of another object may be acquired, thereby further improving the payment channel of palm-scan payment.

According to one or more embodiments of this disclosure, based on receiving the first palm information for the palm-scan payment service and selecting the electronic payment account, the selected first electronic payment account is configured as the electronic payment account associated with the first palm information. In this way, the first electronic payment account may be configured for the palm-scan payment service. Therefore, in the use process of the palm-scan payment service, when the first palm information is received, the configured first electronic payment account associated with the first palm information is adopted for payment. According to the foregoing procedure, based on the configuration operation of the first object, one or more electronic payment accounts associated with the first palm information may be configured. These electronic payment accounts may be configured for the palm-scan payment service. It can be seen that configuration of the payment account is no longer limited to physical payment account types, thereby improving the diversity of payment accounts used for a palm-scan payment service. In addition, the palm-scan payment service supports the integration of various payment instruments, expanding payment channels. When the palm-scan payment service is used, only palm information of the object needs to be provided, so that an associated electronic payment account may be flexibly selected, thereby effectively improving the flexibility and convenience of payment in the palm-scan payment scene.

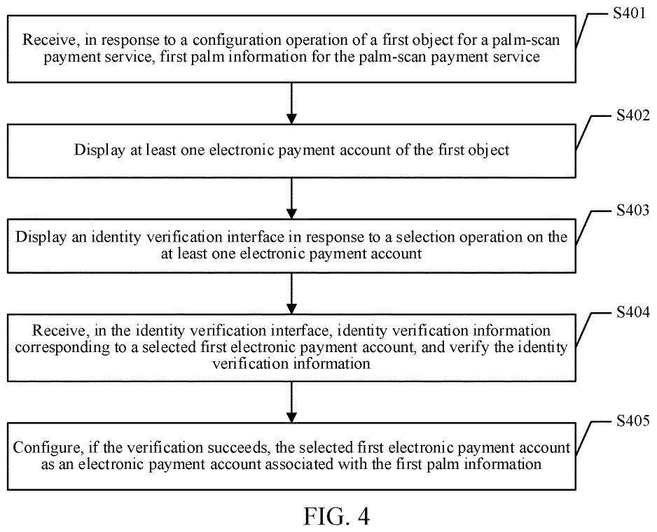

FIG. 4 is a schematic flowchart of another service processing method according to an embodiment of this disclosure. The service processing method may be performed by a first terminal device (for example, the first terminal device 101a shown in FIG. 1). The service processing method may include the following operation S401 to operation S405.

S401: Receive, in response to a configuration operation of a first object for a palm-scan payment service, first palm information for the palm-scan payment service.

S402: Display at least one electronic payment account of the first object.

Operation S401 and operation S402 are the same as operation S201 and operation S202, and may refer to explanations of operation S201 and operation S202. Details are not described herein again.

S403: Display an identity verification interface in response to a selection operation on the at least one electronic payment account. For example, an identity verification interface is displayed based on the selection operation on the selection interface.

The identity verification interface is an interaction interface entered by the user after the user completes payment account selection, and is configured for further confirming an identity of the user and payment permission. The identity verification interface usually includes elements such as an input box, a verification code area, and a biometric recognition prompt. The identity verification interface is designed to confirm that the user has legal operation permission. A function of the identity verification interface is to improve the security of the system, and prevent unauthorized account binding behavior. After the user completes account selection, an identity verification procedure is introduced. By performing the operation of identity verification, misoperation or malicious binding may be effectively avoided.

In some embodiments, an implementation of S403 may include the following content: outputting account authorization prompt information in response to the selection operation on the at least one electronic payment account, the account authorization prompt information being configured for prompting authorization of a selected first electronic payment account; and displaying the identity verification interface in response to an authorization operation performed on the first electronic payment account.

In an implementation, the account authorization prompt information may be displayed in an authorization prompt interface. For example, the first terminal device may display the authorization prompt interface in response to the selection operation on the at least one electronic payment account. The authorization prompt interface includes the account authorization prompt information. The authorization prompt interface further includes an authorization confirmation control. The authorization operation may be a trigger operation for the authorization confirmation control, for example, clicking the authorization confirmation control. In another implementation, the at least one electronic payment account is displayed in an account configuration interface, and the account authorization prompt information is displayed in an authorization prompt message. A presentation form of the authorization prompt message is a message pop-up window, a message notification bar, or the like, and an authorization confirmation control is provided in the authorization prompt message. The authorization operation may be a trigger operation on the authorization confirmation control in the authorization prompt message. Based on the authorization operation performed on the first electronic account, the first terminal device may display the identity verification interface. The identity verification interface may include to-be-inputted identity verification information, for example, a to-be-inputted payment password, or to-be-collected palm information.

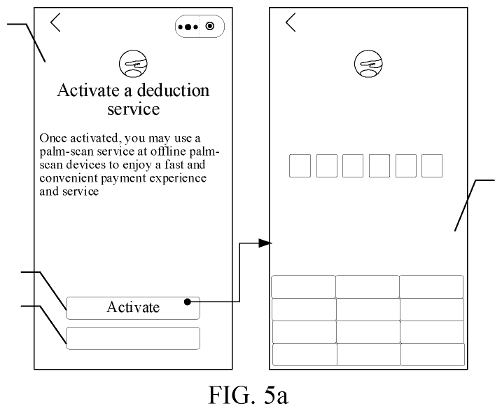

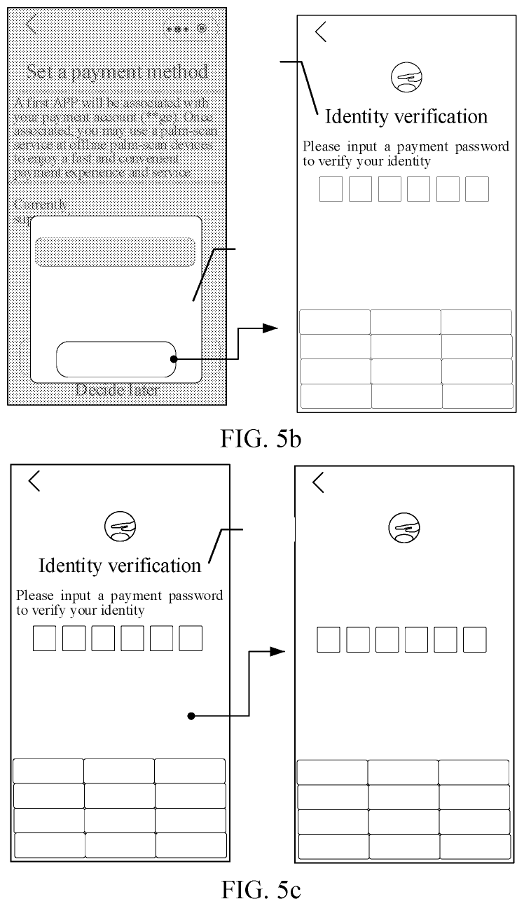

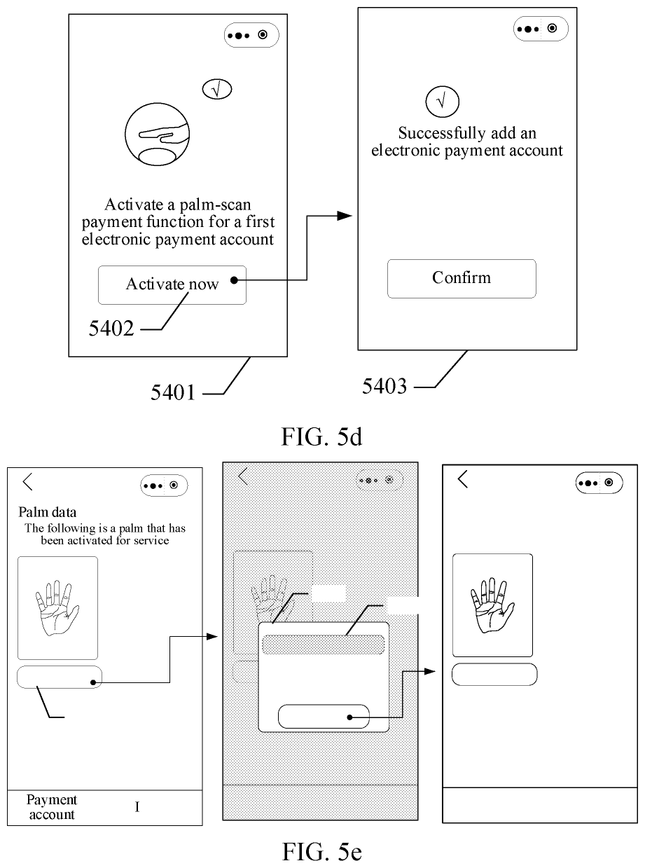

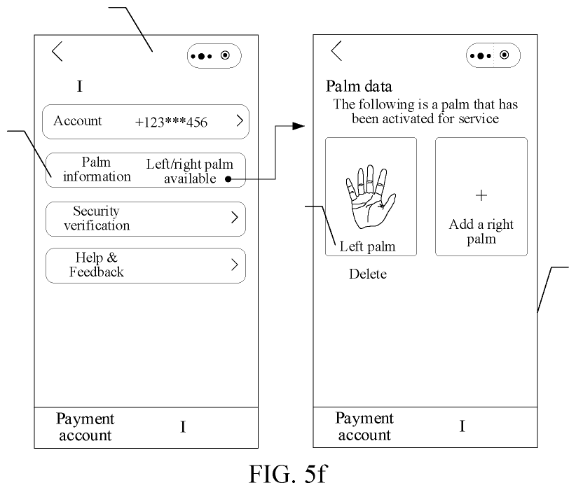

FIG. 5a is a schematic diagram of account authorization prompt information. As shown in the left figure of FIG. 5a, after an electronic payment account is selected, an authorization prompt interface 5100 may be displayed. The following text content is displayed in the authorization prompt interface 5100:“Activate a deduction service”; and “Once activated, you may use the palm-scan service at offline palm-scan devices to enjoy a fast and convenient payment experience and service”. An activation button 5101 and a cancel button 5102 are further displayed in the authorization prompt interface. If the enable button 5101 is clicked, an identity verification interface 5103 may be further displayed. The identity verification interface 5103 includes a to-be-inputted payment password, and the identity of the first object may be verified using the payment password. Based on output of the account authorization prompt information, the first object may confirm whether to authorize the first electronic payment account to be associated with the first palm information, thereby confirming whether to associate the first electronic payment account with the first palm information for a second time. Based on the second confirmation of the first electronic payment account, the first electronic payment account may be authorized to be used for the palm-scan payment service, thereby reducing a misoperation rate of association between the electronic payment account and the first palm information, and enhancing the accuracy of an association intention.

In an implementation, the first terminal device may display at least one identity verification manner in response to the selection operation on the at least one electronic payment account. Each identity verification manner corresponds to one type of identity verification information. After any one of the at least one identity verification manner is selected, the identity verification interface is displayed. The style layout of the identity verification interface matches the selected identity verification manner.

In at least one example, after the first electronic payment account is selected, the at least one displayed identity verification manner may be an identity verification manner supported by the first electronic payment account. The at least one identity verification manner includes one or more of the following: password verification, face-scan verification, palm-scan verification, fingerprint verification, voiceprint verification, iris verification, and the like. Types of identity verification information verified by different identity verification manners are different, and the identity verification information received in the identity verification interface matches the selected identity verification manner. For example, if the first electronic payment account is associated with a payment password and a human face, two identity verification manners: password verification and face-scan verification may be included, to correspondingly verify the payment password and the face information, respectively. If the first electronic payment account is further associated with a palm, the identity verification manner may further include palm-scan verification, to correspondingly verify the palm information. The at least one identity verification manner may be in a to-be-selected state, and may be displayed in a verification manner setting interface. The verification manner setting interface may be a new interface that covers the account configuration interface (configured for displaying the electronic payment account), or may be floatingly or fixedly displayed on the account configuration interface in a form of a window.

The style layouts of the identity verification interfaces corresponding to different identity verification manners are different, to receive identity verification information corresponding to the identity verification manners. After any identity verification manner is selected, an identity verification interface corresponding to the selected identity verification manner may be presented. In some examples, if the first object selects to perform verification through the payment password, a blank box for inputting the payment password may be presented in the identity verification interface (for example, the identity verification interface shown in FIG. 5a). If the first object selects to perform verification through the palm information, an area for collecting a palm image may be presented in the identity verification interface, for example, an interface similar to that for enrolling a palm image in FIG. 3d. The identity verification interface may further include verification prompt information. The verification prompt information is configured for prompting input of corresponding types of identity verification information.

In some examples, the above procedure of displaying the identity verification interface may refer to FIG. 5b. After an MM electronic payment account is selected, a message pop-up window 5201 may be displayed in the account configuration interface. The message pop-up window 5201 includes multiple identity verification manners, which are password verification and palm-scan verification, respectively. After password verification is selected, an identity verification interface 5202 corresponding to password verification may be displayed, and inputting the payment password in the identity verification interface 5202 is supported. In this way, the first object may autonomously select a manner to perform identity verification, thereby achieving the flexible selection of the identity verification manner, and improving the convenience and flexibility of identity verification.

In another implementation, the first terminal device may further display at least one identity verification manner in response to the authorization operation performed on the first electronic payment account. Each identity verification manner corresponds to one type of identity verification information. After any one of the at least one identity verification manner is selected, the identity verification interface is displayed. That is, after the first electronic payment account is selected, the account authorization prompt information may be displayed first, then the identity verification manner shown in FIG. 5b is displayed based on the authorization operation performed on the first electronic payment account, and then the identity verification interface is displayed.

S404: Receive, in the identity verification interface, identity verification information corresponding to the selected first electronic payment account, and verify the identity verification information. For example, identity verification information corresponding to the first selected electronic payment account is received in the identity verification interface. Verification of the identity verification information is performed.

In an implementation, the first object may input the identity verification information in the identity verification interface. The identity verification information corresponds to the first electronic payment account. The identity verification information corresponding to the selected first electronic payment account includes at least one of the following: a payment password of the first electronic payment account, an account identifier of the first electronic payment account, an object identifier corresponding to the first electronic payment account, and biometric feature information associated with the first electronic payment account. The account identifier of the first electronic payment account may be an account number or an account ID of the first electronic payment account, and the object identifier corresponding to the first electronic payment account includes, but is not limited to, an object ID of the first object, an identity number of the first object, a mobile phone number of the first object, and the like. The biometric feature information refers to inherent physiological features of a human body, and includes, but is not limited to, fingerprint, iris, face, palm, voiceprint, and the like. If the palm-scan payment service is provided by the first APP, and the first electronic payment account is provided by the second APP, the backend service side corresponding to the second APP performs verification based on the identity verification information. In addition, if the identity verification information is the biometric feature information (for example, a palm image) associated with the first electronic payment account, during verification, the biometric feature information received in the identity verification interface is compared with source biometric feature information that is associated with the first electronic payment account and managed by the second APP.

FIG. 5c is a schematic diagram of receiving identity verification information in an identity verification interface. After the first electronic payment account is selected, an identity verification interface 5301 may be displayed. The identity verification interface 5301 prompts the first object to input the payment password of the first electronic account. After the first object inputs the payment password in the identity verification interface, the payment password may be displayed in plaintext or ciphertext.

In an implementation, the first terminal device may perform verification based on source information stored in the local space, or the first terminal device may request a server to perform identity verification and transmit the identity verification information to a corresponding backend server (for example, a backend server of a second APP to which the first electronic payment account belongs), so that the backend server verifies the identity verification information and then returns an identity verification result. The first terminal device may receive the identity verification result. The identity verification result is configured for indicating whether verification succeeds. During verification, the backend server may compare the identity verification information with pre-stored source information corresponding to the first electronic payment account; generate, if the identity verification information is consistent with the pre-stored source information, a first identity verification result configured for indicating that the verification succeeds; and generate, if the identity verification information is inconsistent with the pre-stored source information, a second identity verification result configured for indicating that the verification fails. Therefore, the identity verification result received by the first terminal device may include the first identity verification result or the second identity verification result. In a verification process, the first terminal device may display a verification loading bar to prompt a verification progress.

S405: Configure, if the verification succeeds, the selected first electronic payment account as an electronic payment account associated with the first palm information.

In at least one example, if the verification succeeds, the object selecting the first electronic payment account is indeed the first object, and the first terminal device may configure the first electronic payment account as the electronic payment account associated with the first palm information, for example, establish a binding relationship between the selected first electronic payment account and the palm information (for example, image data of an enrolled palm) of the current user, and output a configuration success result. When the binding process is performed, the following operations may further be performed: updating a database record, generating a binding credential, transmitting a confirmation notification, and the like. By binding the electronic payment account to the palm information, the user may complete payment by scanning a palm without carrying a mobile phone or a bank card. A mechanism of binding the electronic payment account to the palm information not only improves the payment convenience, but also enhances the transaction security, because only users who have passed identity verification can complete the binding. In some embodiments, the first palm information can be associated with the first electronic payment account only with the permission or operation of the first object, thereby avoiding incorrect association of the first electronic payment account and improving the security of the association between the electronic payment account and the palm information.

In a feasible implementation, if the verification fails, the identity verification interface may be redisplayed, so that new identity verification information is re-received in the identity verification interface, and the verification operation is re-performed. In some examples, if the verification fails, the identity verification interface shown in FIG. 5a may be redisplayed. Details are not described herein again. In another feasible implementation, if the verification fails, a new identity verification interface may be displayed, and the new identity verification interface is configured for collecting a new type of identity verification information. In some examples, the identity verification interface shown in FIG. 5a is displayed for the first verification, and is configured for receiving the payment password. If the verification fails, an interface similar to that for enrolling a palm image in FIG. 3d may be displayed as the identity verification interface, and is configured for receiving the palm information.

In some embodiments, if the identity verification is automatically performed without interaction information of the object, the first terminal device may directly configure, in response to the authorization operation performed on the first electronic payment account, the first electronic payment account as the electronic payment account associated with the first palm information. FIG. 5d is a schematic diagram of authorization prompt information. After the first electronic payment account is selected, an authorization prompt interface 5401 may be displayed. The authorization prompt interface 5401 includes an authorization button 5402. Text content of the authorization button is: Activate now. After the authorization button is clicked, a backend of the palm-scan payment service may automatically perform identity verification, and when the verification succeeds, output a configuration result 5403 of successfully adding the electronic payment account.

In some embodiments, the first terminal device may receive, in response to a palm addition operation of the first object for the palm-scan payment service, second palm information added for the palm-scan payment service, and configure the first electronic payment account as an electronic payment account associated with the second palm information.

In an implementation, the palm addition operation includes, but is not limited to, one or more of the following: a preset gesture operation, a trigger operation on an addition button in a palm information management interface, and a trigger operation on a physical key. The palm information management interface is configured for displaying the added palm information, for example, displaying the first palm information, and may further be configured for displaying at least one management control for the palm information, such as an addition control, a deletion control, and a modification control. A relationship between the second palm information and the first palm information includes any one of the following. First, the second palm information and the first palm information are different palm information of the same object. For example, the first palm information is a left palm image (a palm image is a palm print image) of the first object, and the second palm information is a right palm image of the first object. Second, the second palm information and the first palm information are different palm information of different objects. For example, the first palm information is palm information of the first object (for example, a left palm image), and the second palm information is palm information of the second object (for example, a right palm image).

In an implementation, a manner of receiving the second palm information and a manner of receiving the first palm information may be the same. For example, in response to the palm addition operation of the first object for the palm-scan payment service, the first terminal device may receive the second palm information in one or more of the following manners. Manner 1: an information collection interface is displayed. The information collection interface is configured for displaying the collection guidance information and presenting a second palm image of a corresponding action according to the collection guidance information, and the first terminal device may capture the second palm image of the corresponding action and use the second palm image as the second palm information. Manner 2: the palm information enrollment invitation is outputted and transmitted to the second object, so that the first terminal device may receive the palm information of the second object. When the electronic payment account (for example, the first electronic payment account) for the palm-scan payment service is configured, the palm information of the second object is used as the second palm information, and may be automatically associated with the configured electronic payment account. Manner 3: a palm information storage medium storing palm information is acquired, and in response to recognition of the palm information storage medium, the palm information stored in the palm information storage medium is received.

If before the second palm information is received, the first electronic account is already configured as the electronic payment account associated with the first palm information, the first electronic account may be automatically configured as the electronic payment account associated with the second palm information, without a process such as identity verification. If after the second palm information is received, the first electronic account is not configured as the electronic payment account associated with the first palm information, the first electronic payment account may be configured as the electronic payment account associated with the second palm information through identity verification in S403 to S406. When the first electronic payment account is configured as the electronic payment account associated with the first palm information, identity verification does not need to be performed. In some embodiments, the first terminal device may synchronously receive the first palm information and the second palm information in response to the configuration operation of the first object for the palm-scan payment service, and the first palm information and the second palm information are different palm information of the same object or palm information of different objects, so that the first electronic payment account is configured as the electronic payment account associated with the first palm information, and as the electronic payment account associated with the second palm information. That is, the first electronic payment account is configured as the electronic payment account for the palm-scan payment service, and is associated with the first palm information and the second palm information.

Therefore, the first electronic account is associated with two pieces of palm information, so that the convenience of palm-scan payment can be improved. In some embodiments, one electronic account may be associated with one or more pieces of palm information, the palm information received by the configuration operation and the palm addition operation of the first object for the palm-scan payment service may be managed under the account of the first object in the first APP, and one piece of palm information may alternatively be associated with one or more electronic accounts. An owner of each electronic account is the first object.

In some embodiments, the palm-scan payment service supports configuring N pieces of palm information. N is a positive integer. The N pieces of palm information include at least one piece of palm information of the first object, and may further include at least one piece of palm information of the second object. The first terminal device may manage the N pieces of palm information. The management of the N pieces of palm information may include one or more of the following: deletion, addition, replacement, modification, and the like. It is assumed that any one of the N pieces of palm information is represented as palm information n, n being a positive integer. In some examples, n ranges from 1 to N. The palm information n includes one or two of a palm print image and a palm vein image. For example, each piece of palm information among the N pieces of palm information includes a palm print image. Any palm information (denoted as palm information n) is used as an example for description, and management of the palm information n includes at least one of the following management manners.

Management manner 1: Set a palm identifier for the palm information n. The palm identifier may be a name of the palm information. For example, the left palm information is named the left palm. For another example, the left palm information of the first object is named palm 01. The first terminal device may set the palm identifier of the palm information n in response to an identifier setting operation for the palm information n. The identifier setting operation herein includes but is not limited to: a preset operation for the palm information (for example, an operation of double-clicking a palm image), and a selection operation on a to-be-set palm identifier. In at least one example, the first terminal device may display at least one preset palm identifier in response to a setting operation of the palm identifier. If any preset palm identifier is selected, the selected palm identifier may be set as the palm identifier of the palm information n. FIG. 5e is a schematic diagram of setting a palm identifier. After an identifier setting box 5501 below the left palm image is clicked, a message window 5502 is displayed. The message window 5502 includes two preset palm identifiers. After a first preset palm identifier 5503 is selected, a preset palm identifier 5503: left palm 01 may be displayed in the identifier setting box 5501. It can be seen that by providing the preset palm identifier for selection, manual input of the palm identifier is avoided, thereby improving the operation convenience. In at least another example, the first terminal device displays an identifier editing bar in response to the setting operation of the palm identifier, receives the palm identifier inputted in the identifier editing bar, and sets the palm identifier for the palm information n. In this manner, the object may customize the palm identifier, satisfying a personalized requirement.

Management manner 2: Display the palm information n. A manner for displaying the N pieces of palm information may include one or more of the following: categorizing and displaying according to the associated object (such as the first object and the second object), categorizing and displaying according to the associated body part (such as the left hand and the right hand), and arranging and displaying according to the time points at which they are received. A palm print image may be displayed based on content included in the palm information n, and N palm images may be displayed in the palm information management interface. The palm information management interface is obtained based on triggering a palm information management button in an APP management interface. In some examples, N pieces of palm information are displayed as shown in FIG. 5f. The first terminal device may display an APP management interface 5600, and may display a palm information management interface 5602 by clicking a palm information management control (that is, a control 5601 of “palm information”) in the management interface. A left palm image 5603 of an object A is displayed in the palm information management interface 5602. Since the palm information of the right palm is not enrolled, an addition button for a right palm image of the object A is further displayed in the palm information management interface. After the addition button is clicked, the first terminal device may collect the right palm image of the object A and display the right palm image in the palm information management interface.

Management manner 3: Delete the palm information n. The first terminal device may delete the palm information n in response to a deletion operation on the palm information n. In some examples, a deletion control is displayed below the left palm image shown in FIG. 5f, and the left palm image may be deleted by clicking the deletion control. After the palm information n is deleted, the deleted palm information n is not displayed, and the palm information n is no longer used for the palm-scan payment service. For example, if the palm information n is associated with the first electronic payment account, after the palm information n is deleted, the association between the first electronic payment account and the palm information n may be automatically released.

Management manner 4: Modify the palm information n. Modifying the palm information n may include replacing the palm information n with new palm information (for example, replacing with a new palm print image), or modifying a palm identifier of the palm information n. If replaced with new palm information, the first electronic account may be automatically associated with the new palm information.

Based on the above management manners, the palm information may be flexibly and autonomously managed, thereby improving the convenience of palm information management.

According to one or more embodiments of this disclosure, after responding to the selection of the first electronic payment account, the first terminal device may receive the identity verification information through the identity verification interface to perform verification of the first electronic payment account, thereby improving the security of the association between the electronic payment account and the palm information, and further enhancing the use security of the electronic payment account. In addition, the first object may further add other palm information for the palm-scan payment service. The addition of the palm information may enable the palm-scan payment service to support a plurality of pieces of palm information. For example, in the palm-scan payment service, not only a left palm image is enrolled, but also a right palm image is enrolled, so that during palm-scan payment, the first electronic payment account can be used for payment using any hand, thereby improving the convenience of palm-scan payment.

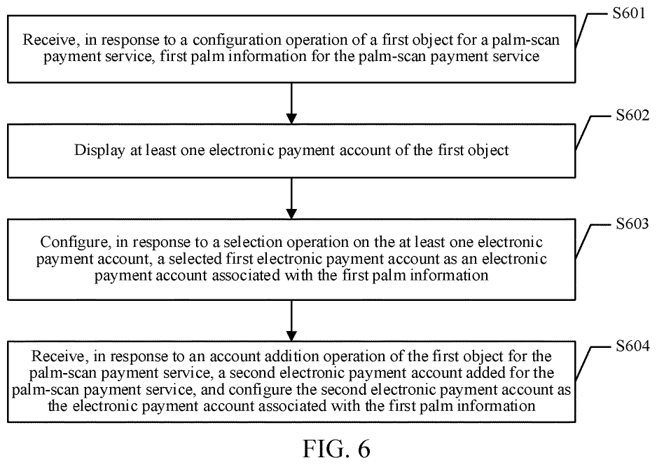

FIG. 6 is a schematic flowchart of another service processing method according to an embodiment of this disclosure. The service processing method may be performed by a first terminal device (for example, the first terminal device 101a shown in FIG. 1). The service processing method may include the following operation S601 to operation S604.

S601: Receive, in response to a configuration operation of a first object for a palm-scan payment service, first palm information for the palm-scan payment service.

S602: Display at least one electronic payment account of the first object.

S603: Configure, in response to a selection operation on the at least one electronic payment account, a selected first electronic payment account as an electronic payment account associated with the first palm information.

In some examples, operation S601 to operation S603 may refer to the descriptions in the embodiments shown in FIG. 2 or FIG. 4. Details are not described herein again.

S604: Receive, in response to an account addition operation of the first object for the palm-scan payment service, a second electronic payment account added for the palm-scan payment service, and configure the second electronic payment account as the electronic payment account associated with the first palm information.

In some embodiments, when using the palm-scan payment service, the user may hope to bind a plurality of electronic payment accounts to satisfy different consumption scenes or preferences. The account addition operation refers to a new account binding request actively initiated by the user through the first terminal device. In at least one example, the account addition operation includes, but is not limited to: a preset gesture operation, a trigger operation on an addition control in an account management interface, and a preset operation on a physical control. For example, a user may choose to add a payment account of an instant messaging APP or another supported third-party e-Wallet account on a mobile phone. After receiving an account addition operation request, the first terminal device verifies the user identity and confirms that the operation meets security standards, and then incorporates the second electronic payment account into a palm-scan payment system. The process of the account addition operation may improve the payment flexibility of the user. The account management interface may be configured for displaying the electronic payment accounts for the palm-scan payment service, and these electronic payment accounts are associated with each piece of received palm information.

In an implementation, in response to the addition operation of the first object for the palm-scan payment service, the first terminal device may display at least one electronic payment account of the first object that is allowed to be associated. The owners of all of these electronic payment accounts that are allowed to be associated are the first object, and all of these electronic payment accounts support being used for the palm-scan payment service. On the premise that the first electronic payment account is configured for the first palm information, the displayed electronic payment accounts include other electronic payment accounts except the configured first electronic payment account. When any electronic payment account is selected, the selected electronic payment account may be used as the second electronic payment account, so that the second electronic payment account is configured as the electronic payment account associated with the first palm information. An owner of the second electronic payment account is the first object, and the first electronic payment account is different from the second electronic payment account. For example, the first electronic payment account is an electronic payment account provided by a second APP AA, the second electronic payment account is an electronic payment account provided by a second APP BB, and the second APP AA and the second APP BB are different third-party payment platforms.

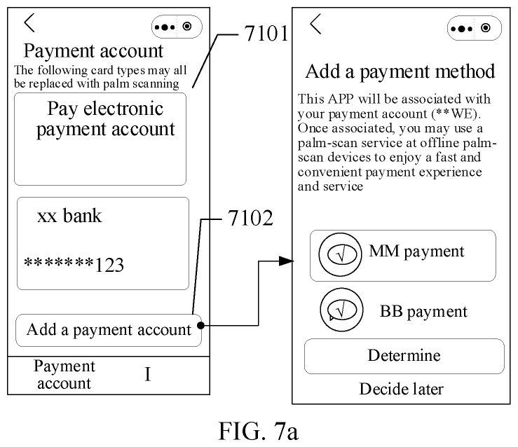

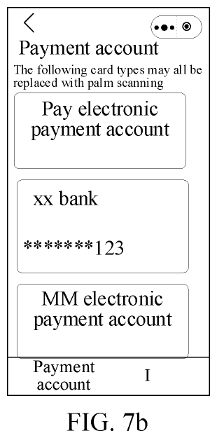

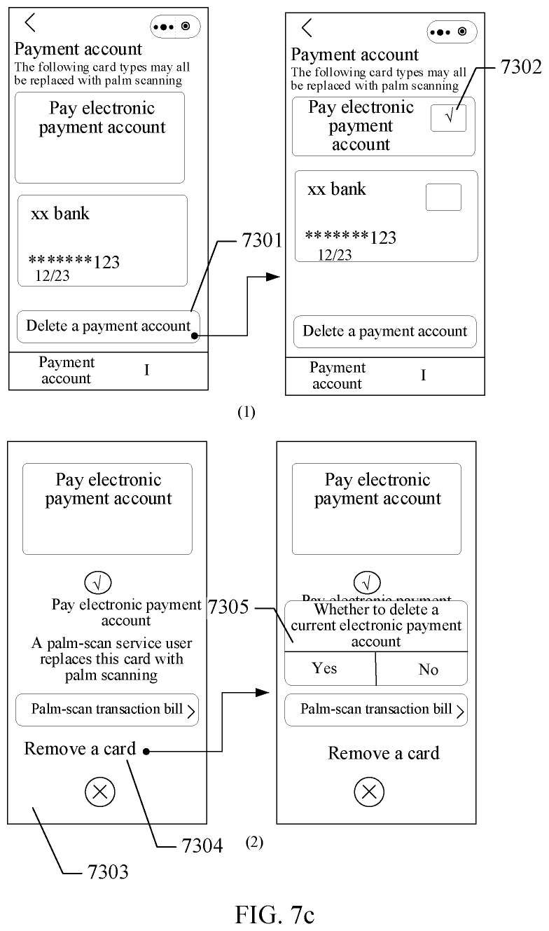

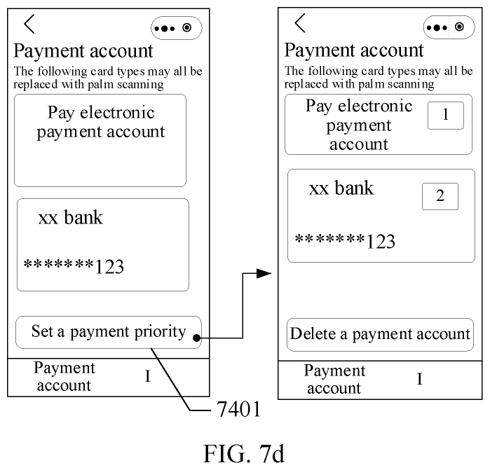

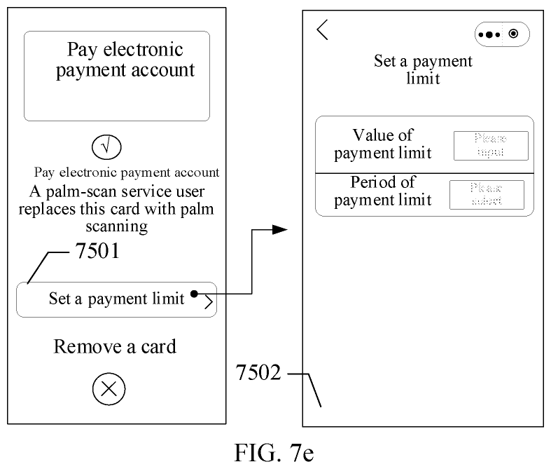

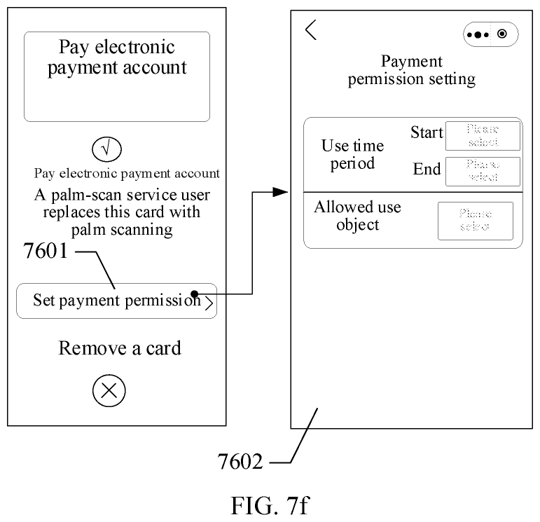

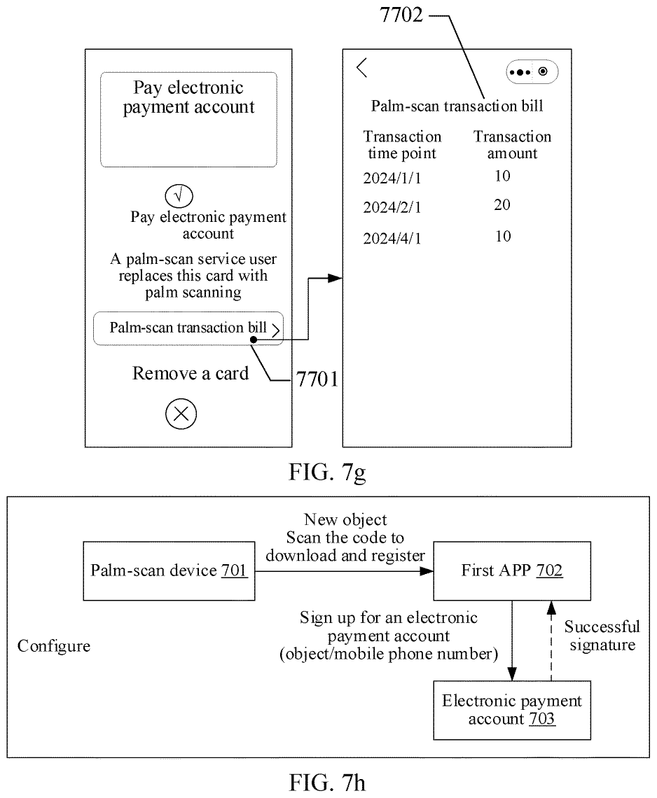

FIG. 7a is a schematic diagram of adding a second electronic payment account. The first terminal device may display an account management interface 7101. When an account addition control 7102 in the account management interface 7101 is clicked, one or more electronic payment accounts may be displayed, and based on selection of any electronic payment account, the electronic payment account is configured as the electronic payment account associated with the first palm information.

In another implementation, the second electronic payment account is the electronic payment account of the second object. In response to an addition operation of the first object for the palm-scan payment service, the first terminal device may display multiple association ways. The association ways include a first association way and a second association way. The first association way is configured for instructing to associate the electronic payment account of the first object, and the second association way is configured for instructing to associate the electronic payment account of the second object. If the first association way is selected, performing the operation of displaying the electronic payment account of the first object is triggered. If the second association way is selected, an account association invitation is outputted and transmitted to the second object. The second object may return the electronic payment account of the second object based on the account association invitation. The first terminal device may configure the electronic payment account of the second object as the electronic payment account associated with the first palm information, that is, the owner of the second electronic payment account for the palm-scan payment service is the second object.

When the second electronic payment account is configured, configuration operations similar to those of the first electronic payment account may be performed. For example, an identity verification interface is first displayed, and the identity verification information corresponding to the second electronic payment account is received in the identity verification interface and then verified. After the verification succeeds, the second electronic payment account is configured as the electronic payment account associated with the first palm information. Since the first electronic payment account and the second electronic payment account are configured for the first palm information as associated electronic payment accounts, in the palm-scan payment service using the first palm information, based on selection of an electronic payment account by a payment object, payment may be performed using the configured first electronic payment account associated with the first palm information, or payment may be performed using the configured second electronic payment account associated with the first palm information.

A configuration order of the first electronic payment account and the second electronic payment account is not limited in this disclosure. For example, after receiving the first palm information and before configuring the first electronic payment account as the electronic payment account associated with the first palm information, the first terminal device may first perform S604, so that an electronic payment account of the first object that is not associated with the first palm information may be displayed, and the second electronic payment account associated with the first palm information may be configured for the palm-scan payment service. The first terminal device may alternatively perform S604 after configuring the first electronic payment account as the electronic payment account associated with the first palm information, so that the electronic payment accounts associated with the first palm information include the first electronic payment account and the second electronic payment account.

In some embodiments, the palm-scan payment service supports configuring M electronic payment accounts associated with the first palm information for payment, M being a positive integer. The first terminal device may further manage the M electronic payment accounts. Owners of the M electronic payment accounts are all the first object. In at least one example, the palm-scan payment service is provided by the first APP, and the M electronic payment accounts may be managed under accounts registered by the first object in the first APP. The management of the M configured electronic payment accounts includes, but is not limited to, deleting an electronic account, and setting payment information (such as a payment priority, a payment limit, and payment permission) of an electronic account.

The management of one electronic payment account is used as an example below for description. It is assumed that any one of the M electronic payment accounts is represented as an electronic payment account m, m is a positive integer, and m is less than or equal to M. In some examples, m ranges from 1 to M. The management of the electronic payment account m includes at least one of the following manners.

Management manner 1: Set an account identifier for the electronic payment account m. The account identifier of the electronic payment account m may be customized by the first object. The account identifier includes, but is not limited to, an account name, an account number, and the like. For example, the account identifier is text content such as the following customized account names: payment account 01, payment account of Xiaoming, and the like. The account identifier set herein may further be used for auxiliary verification in the use procedure of the palm-scan payment service. That is, when the palm-scan payment service is used, an inputted account identifier may further be used for verification of an electronic payment account. For example, the inputted account identifier needs to be consistent with the set account identifier to pass the verification, so that the payment service continues to be provided. In a feasible implementation, an account style may further be set for the electronic payment account m. The account style is configured for defining a presentation style of the electronic payment account. For example, in the account management interface, each electronic payment account is presented in a form of a virtual card, and a presentation pattern, an accessory, and the like may be set for the virtual card. Through the setting of the account style, scenes of customized account settings may be enriched, and account management is more interesting.

Management manner 2: Display the electronic payment account m. The display form of the electronic payment account includes, but is not limited to, a virtual card, an account name, a virtual card bag, and the like. The M electronic payment accounts may be displayed in the account management interface, and the account management interface is provided by the first APP. Manners for displaying and arranging the M electronic payment accounts include, but are not limited to: arranging and displaying in various manners without a particular order, arranging and displaying according to account configuration timestamps (for example, from latest to earliest), arranging and displaying according to account available limits (for example, in descending order), arranging and displaying according to account names (for example, in alphabetical order by the first character from A to Z), and arranging according to payment priorities (for example, in descending order) of accounts. FIG. 7b is a schematic diagram of displaying M electronic payment accounts. Three electronic payment accounts are arranged and displayed in the account management interface in reverse chronological order according to account configuration timestamps.

Management manner 3: Delete the electronic payment account m. The first terminal device may delete the electronic payment account m in response to a deletion operation on the electronic payment account m. The deletion operation includes, but is not limited to, triggering of a deletion control, a preset gesture operation, and the like. The deletion control may be fixedly displayed in the account management interface, or may be hidden in the account management interface, may be activated after performing a preset operation (such as left-sliding, long-pressing, or continuous clicking) on the electronic payment account m, or may be fixedly displayed in a detail interface of the electronic payment account m. In an implementation, in response to triggering of the deletion control, the M electronic payment accounts may be displayed in a to-be-selected state. After the electronic payment account m is selected, the electronic payment account m may be deleted. FIG. 7c is a schematic diagram of deleting an electronic payment account. As shown in part (1) of FIG. 7c, after a control of removing a card 7301 fixedly displayed in the account management interface is clicked, a check box may be displayed around each electronic payment account. After any one or more electronic payment accounts are selected, for example, a pay electronic payment account is selected, a pattern corresponding to a checked state may be displayed in a check box 7302, so that the selected electronic payment account may be deleted. When a plurality of electronic payment accounts are selected, batch deletion may further be implemented. As shown in part (2) of FIG. 7c, after removing a card 7304 in a detail interface 7303 of the electronic payment account is clicked, confirmation prompt information 7305 may be outputted, and the electronic payment account m is deleted after confirmation is clicked.

After the electronic payment account m is deleted, the electronic payment account m is no longer used for the palm-scan payment service, and the association relationship between the electronic payment account m and all the associated palm information may be released. For example, the association relationship between the electronic payment account m and the first palm information may be released. If the electronic payment account m is further associated with other palm information (such as the second palm information), the association relationship between the electronic payment account m and the second palm information can further be released.

Management manner 4: Set a payment priority of the electronic payment account m. In an implementation, the first terminal device may set the payment priority of the electronic payment account m in response to a payment priority setting operation. The payment priority may be configured for indicating a priority use order during palm-scan payment. A higher payment priority indicates an earlier priority use order during palm-scan payment. The payment priority setting operation includes, but is not limited to: a preset gesture operation, a trigger operation on a payment priority control in a detail interface of the electronic payment account m, and a trigger operation on a global priority setting control in the account management interface. The detail interface of the electronic payment account m may be triggered to display in response to a selection operation on the electronic payment account m displayed in the account management interface. Payment priorities of the M electronic payment accounts may be set with one click based on the global priority setting control, and the payment priority of the electronic payment account m may be set individually based on the payment priority control in the detail interface, achieving the setting one by one.

In some examples, as shown in FIG. 7d, a global priority setting control 7401 is further provided in the account management interface. The global priority setting control 7401 is clicked to set the payment priorities of all configured electronic payment accounts with one click. For example, the payment priority of the electronic payment account m is set to 1 (the highest priority), and payment priorities of other electronic payment accounts are set to 2. Then, the electronic payment account m is used as a primary payment account. When the palm-scan payment service is used, the electronic payment account m may be prioritized to be used for payment. In addition, priorities of other electronic payment accounts except the primary account may be set to be the same, and the other electronic payment accounts may be displayed during payment, to facilitate selection by the object.

Management manner 5: Set a payment limit of the electronic payment account m. The first terminal device may set the payment limit of the electronic payment account m in response to a payment limit setting operation on the electronic payment account m. The payment limit setting operation includes, but is not limited to, any one or more of the following: a preset gesture operation, a trigger operation on a payment limit control in the detail interface of the electronic payment account m, and triggering of a preset physical key. Setting content of the payment limit includes at least one of the following: a daily payment limit, a weekly payment limit, a monthly payment limit, and an annual payment limit. FIG. 7e is a schematic diagram of setting a payment limit of an electronic payment account. After a payment limit control 7501 in the detail interface of the electronic payment account m is clicked, a payment limit setting interface 7502 may be displayed. The payment limit setting interface 7502 includes a value and a period (for example, daily, weekly, monthly, quarterly, or annual) of a to-be-set payment limit. If the payment limit inputted by the first object is 10 yuan, and the daily period is selected, after a confirmation control is clicked, the first terminal device may set the daily payment limit of the electronic payment account to 10 yuan.

Management manner 6: Set payment permission of the electronic payment account m. The first terminal device may set the payment permission of the electronic payment account m in response to a payment permission setting operation on the electronic payment account m. The payment permission setting operation includes, but is not limited to, any one or more of the following: a preset gesture operation, a trigger operation on a payment permission control in the detail interface of the electronic payment account m, and triggering of a preset physical key. The payment permission includes at least one of the following: an allowed time period, and at least one allowed object.

For example, FIG. 7f is a schematic diagram of setting payment permission of an electronic payment account. After a payment permission control 7601 in the detail interface is clicked, a payment permission setting interface 7602 may be displayed. A to-be-set use time period and a to-be-set use object are displayed in the payment permission setting interface 7602. For example, when the first object selects a starting timestamp 7:00 and an ending timestamp 23:00, the first terminal device may set an allowed time period of the electronic payment account m to be 7:00-23:00, so that when the palm-scan payment service is used, if the time period falls within the allowed time period, the electronic payment account m is allowed to be used for payment. However, if the time period falls within a time period from 23:00 to 7:00 the next day, the electronic payment account m is prohibited from being used for payment. The at least one allowed object may be an object except the first object, for example, the second object. The permission may be set by the first object. Based on the payment permission setting operation, an object list may be displayed. The object list includes at least one object. These objects are images in which palm information is enrolled for the account of the first object. In response to selection of one or more objects in the object list, the first terminal device may set at least one selected object as an object that is allowed to use the palm-scan payment service.

In some embodiments, the first terminal device may further display a bill for the electronic payment account m in response to a bill viewing operation on the electronic payment account m. The bill viewing operation includes, but is not limited to, a preset gesture operation, and a trigger operation on a bill detail button in the detail interface of the electronic payment account m. The bill for the electronic payment account m is configured for recording at least one transaction involved in payment using the electronic payment account m in the palm-scan payment service. Each transaction includes, but is not limited to, a transaction amount, a transaction object, a transaction time point, a transaction place, and the like. FIG. 7g is a schematic diagram of displaying a bill for an electronic payment account. When a bill detail button 7701 in the detail interface of the electronic payment account m is clicked, a bill 7702 for the electronic payment account m may be presented. The bill includes three transactions using the electronic payment account m for payment in the use process of the palm-scan payment service, and each transaction includes a transaction amount and a transaction time point. Through the bill of the electronic payment account, the transactions of the first object through the electronic payment account m may be automatically recorded, and a bill query function is provided, so that the object can conveniently view the transaction when the object has a corresponding query requirement. The bill for the electronic payment account m further supports categorized viewing of transactions, for example, categorized viewing according to transaction objects or categorized viewing according to transaction amounts.

The service processing procedure mentioned in FIG. 2, FIG. 4, and FIG. 6 may be the configuration procedure of the palm-scan payment service. For the technical logical support of the foregoing product presentation, in an implementation, the palm-scan payment service is provided by the first APP, and the first terminal device may register an account in the first APP in response to an account registration operation of the first object. In some examples in view of FIG. 7h, the first object is a new user that has not registered an account in the first APP. In response to a scanning operation on a graphic code on a palm-scan device 701, the first terminal device may download a first APP 702 and register an account. Next, the first APP may sign up for an electronic payment account 703, and the electronic payment account 703 may return a successful signature result to the first APP 702. A registration process may refer to a schematic diagram of a configuration procedure of a palm-scan payment service shown in FIG. 7h.

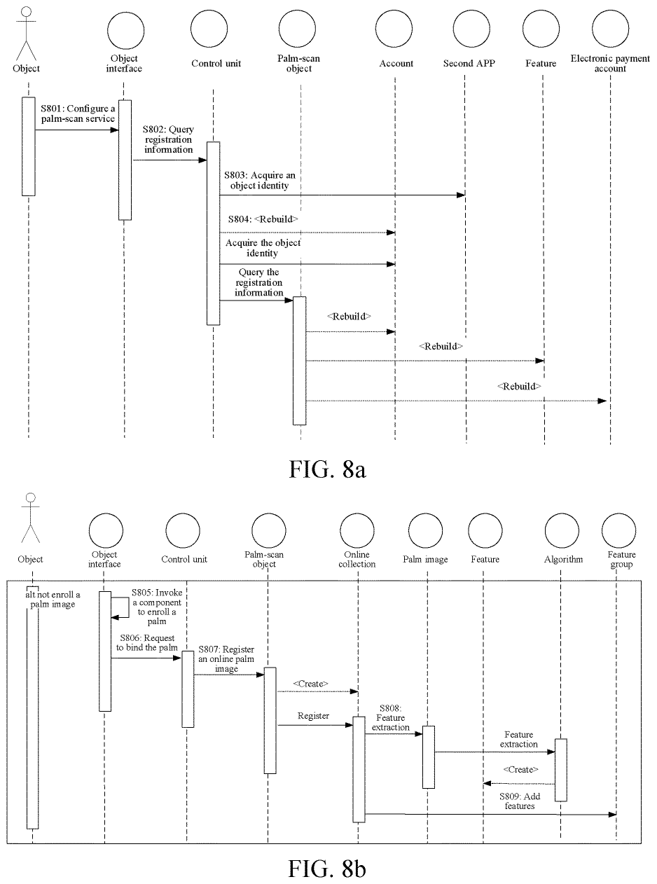

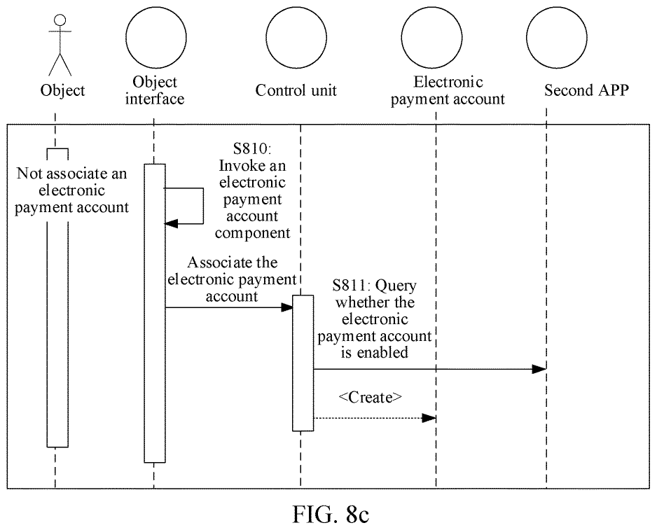

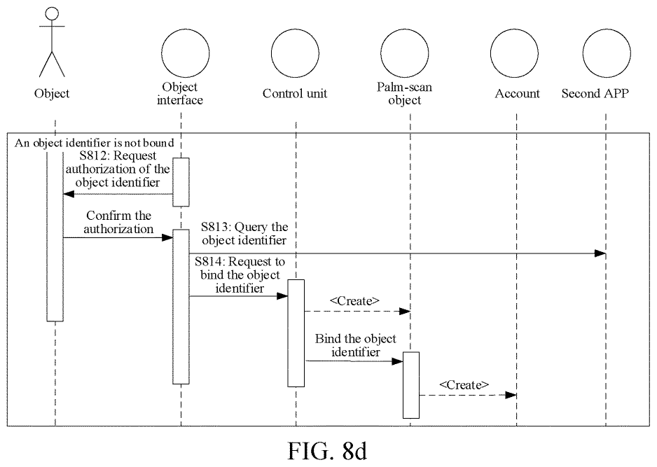

In more detail, the foregoing registration process may include the following content. In response to the configuration operation of the first object for the palm-scan payment service, the first terminal device queries configuration information of the first object for the palm-scan payment service. In at least one example, the first terminal device may query the configuration information of the first object for the palm-scan payment service from a server. The palm-scan payment service is provided by the first APP, and the server is an APP server providing a data service for the first APP. The configuration information is configured for indicating a configuration status of the first object for the palm-scan payment service. The configuration information includes registration information. For example, the configuration information indicates that the first object has registered an account of the first APP, but one or more of the following cases may exist: the palm information is not enrolled, the object identifier is not bound, and the electronic payment account is not associated. In some examples, in a configuration procedure of a palm-scan payment service shown in FIG. 8a, in operation S801, the object may configure a palm-scan service in an object interface (for example, a user interface). In operation S802, a control unit configured with the palm-scan payment service is requested to query registration information. In operation S803, the control unit may acquire an object identity from a second APP, register an account (that is, rebuild), then acquire an object account, and query registration information. If the account of the palm-scan object is not bound to its own object identifier, in operation S804, the registered account is associated with the object identifier through the rebuild operation. If the palm-scan object does not enroll palm information, features may further be collected through the rebuild operation. If the palm-scan object is not associated with an electronic payment account, the electronic payment account may further be associated through the rebuild operation. Therefore, based on indication of the configuration information, one or more of the following cases may be performed.

Case 1: If the configuration information indicates that the first object does not enroll the first palm information for the palm-scan payment service, a palm image of the first object is collected, and feature extraction is performed on the palm image to obtain the first palm information.

FIG. 8b is a schematic flowchart of enrolling a palm image. The first terminal device may invoke, through an object interface, a component to enroll a palm in operation S805. Then, in operation S806, the object interface may request the control unit of the palm-scan payment service to bind a palm. Later, in operation S807, the control unit of the palm-scan payment service registers an online palm image (that is, the palm image collected by the first terminal device) for the palm-scan object, and may invoke a photographing module of the first terminal device or a photographing device connected to the first terminal device to capture the palm of the first object by requesting online collection for registration, to obtain a palm image of the first object. Then, after feature extraction is performed on the collected palm image in operation S808, one or both of the palm print image and the palm vein image may be obtained as the first palm information, so that the first terminal device may receive the first palm information for the palm-scan payment service. The first palm information obtained through feature extraction may be added to a feature group in operation S809, so as to provide retrieval content during palm-scan payment.

Case 2: If the configuration information indicates that the first palm information is not associated with any electronic payment account, enabling permission of the electronic payment account of the first object is queried, and at least one electronic payment account of the first object is acquired when the enabling permission indicates that the electronic payment account is enabled.

In at least one example, the first terminal device may query, from backend servers respectively corresponding to the electronic payment accounts of the first object, whether the electronic payment account is enabled, that is, whether the electronic payment account is activated. When any electronic payment account is enabled, the first terminal device may acquire and display the electronic payment account, and the first APP supports accessing the electronic payment account. For example, the first APP supports accessing electronic payment accounts of three payment platforms, but the first object only enables electronic payment accounts of two of the payment platforms, so that two enabled electronic payment accounts may be acquired, so as to display the electronic payment accounts, and associate the electronic payment accounts with the palm information based on an interaction operation of the object. FIG. 8c is a schematic flowchart of associating an electronic payment account. In operation S810, an electronic payment account component may be invoked in a corresponding object interface to request a control end of the palm-scan payment service to associate an electronic payment account with first palm information, so that the control unit may query, in operation S811, from a second APP whether the electronic payment account is enabled, that is, query whether the electronic payment account provided by the second APP is activated, and when the electronic payment account is activated, the electronic payment account supports an association (that is, create) with the first palm information.

Case 3: If the configuration information indicates that the account of the first object in the first APP is not associated with the object identifier of the first object, when it is confirmed that the object identifier of the first object is authorized, the account of the first object in the first APP is associated with the object identifier of the first object.

In at least one example, authorization request information may be displayed. The authorization request information is configured for requesting to authorize the object identifier (for example, authorize a mobile phone number) of the first object. After the first object confirms the authorization, the object identifier of the first object may be queried from the second APP. After the object identifier of the first object is queried, the object identifier of the first object is bound to a palm-scan object (that is, an object whose account has been registered in the first APP). FIG. 8d is a schematic flowchart of associating an object identifier of a first object. The object identifier of the first object is a mobile phone number of the first object. In operation S812, authorization of the object identifier (for example, a phone number) may be requested in an object interface. After the object confirms the authorization, the object identifier may be queried from the second APP in operation S813, and a control unit of a palm-scan payment service is requested to bind the object identifier in operation S814. If the first object does not register an account in the first APP, an account may further be registered (that is, created) based on the object identifier to become a palm-scan object, and then the object identifier is bound to the palm-scan object, thereby obtaining an account associated with the object identifier.

According to one or more embodiments of this disclosure, after the associated first electronic payment account is configured for the first palm information, the second electronic payment account associated with the first palm information continues to be configured for the palm-scan payment service. Based on configuration of the first electronic payment account and the second electronic payment account, the first palm information may be associated with the two electronic payment accounts, facilitating convenient use of the electronic payment account during palm-scan payment. In addition, the first terminal device may further manage M electronic payment accounts configured for the palm-scan payment service, thereby realizing flexible binding and deletion of the electronic payment accounts, and improving autonomy of association of the electronic payment accounts. In addition, the payment priority, the payment limit, the payment permission, and the like of the electronic payment account may further be set, which improves the diversity of settings of the electronic payment accounts and may satisfy personalized requirements.

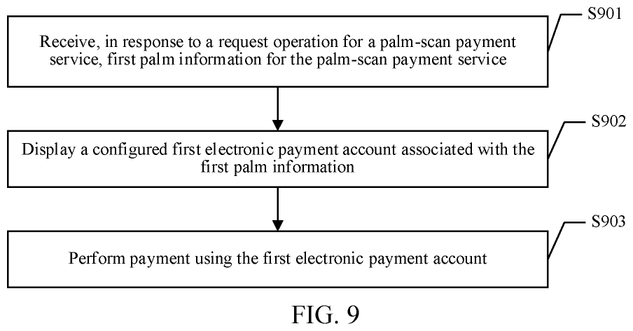

FIG. 9 is a schematic flowchart of a service processing method according to an embodiment of this disclosure. The service processing method may be performed by a second terminal device (for example, the second terminal device 101b shown in FIG. 1). The service processing method may include the following operation S901 to operation S903.

S901: Receive, in response to a request operation for a palm-scan payment service, first palm information for the palm-scan payment service. For example, first palm information for the palm-scan payment service is received by processing circuitry of a terminal device based on a request operation for a palm-scan payment service.

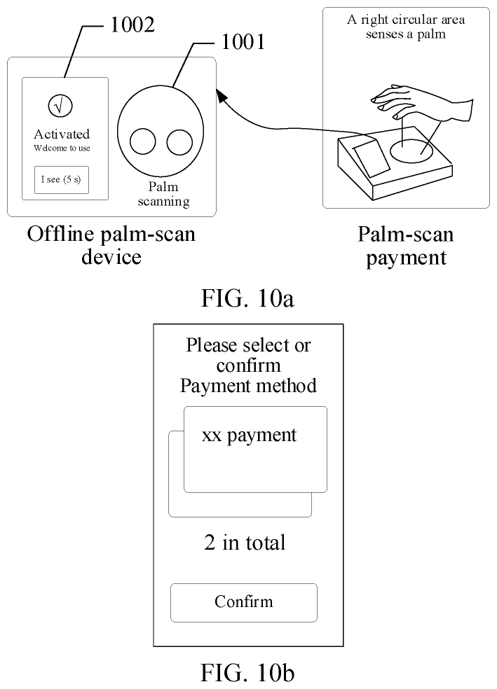

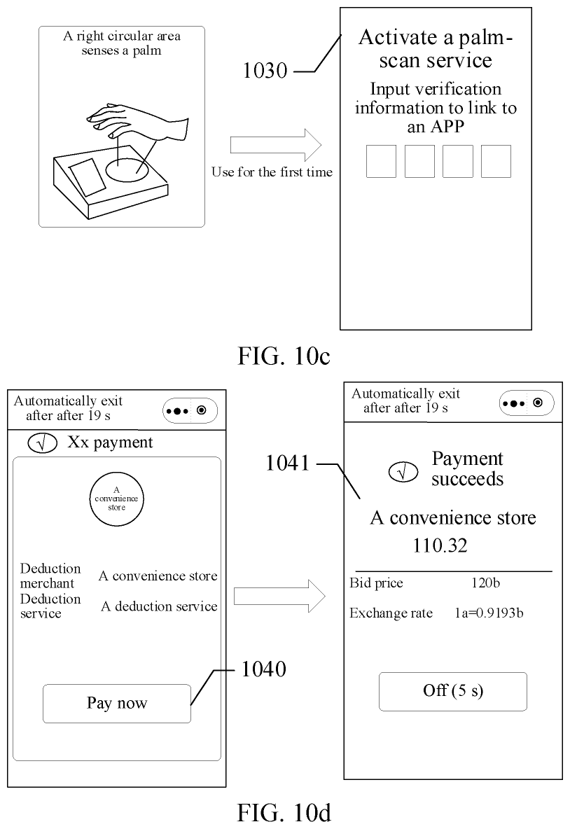

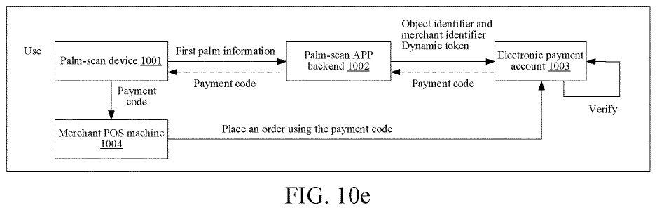

In at least one example, the request operation for the palm-scan payment service may be initiated by a transaction object through the second terminal device. For example, when the palm-scan payment service is used at an offline convenience store, the request operation is initiated after code scanning settlement is performed on commodities. The second terminal device may collect the first palm information for the palm-scan payment service in response to the request operation, for example, collect the palm information of the payment object, and then perform payment based on the electronic payment account (for example, the electronic payment account m) bound to the palm information of the payment object. FIG. 10a is a schematic diagram of receiving first palm information for a palm-scan payment service. The second terminal device is a palm-scan device of an offline store. The second terminal device is provided with a palm sensing area 1001 and a display screen 1002. When the first subject performs palm scanning, the palm may be placed above the palm sensing area without physical contact, to receive a palm image of the first object, and display at least one electronic payment account associated with the palm image on the display screen. That is, after the user completes identity verification on the palm-scan device of the offline store, the second terminal device may trigger a request operation for the palm-scan payment service. The request operation for the palm-scan payment service is usually actively initiated by the user. For example, the palm is placed on a biometric recognition sensor of a device, or payment willingness is confirmed in another manner (for example, clicking a button). The first palm information refers to hand biometric feature data, such as a palm print image and a living body detection result, that is collected by a palm-scan device and transmitted to the second terminal device for identity recognition and payment verification. After the first palm information is encrypted, the first palm information is securely transmitted to a payment system for subsequent processing.

The first palm information, as a core basis of user identity verification, can effectively prevent an access and payment behavior of an unauthorized user, thereby improving the payment security. In addition, by using the first palm information for identity verification, the user does not need to carry a mobile phone or a bank card, so that the payment procedure is simplified, and the user experience is improved.

S902: Display a configured first electronic payment account associated with the first palm information. For example, account identification information of a plurality of configured electronic payment accounts associated with the first palm information is displayed in a selection interface.

In an implementation, the first electronic payment account is associated with the first palm information at a configuration stage, and when the palm-scan payment service is used, the first electronic payment account may be used for payment based on the first palm information. The second terminal device may display a payment method interface. The payment method interface is configured for displaying the configured electronic payment account associated with the first palm information, for example, the first electronic payment account. In some examples, at the configuration stage of the palm-scan payment service, an electronic payment account aa associated with the first palm information has been configured for the palm-scan payment service, so that at a use stage of the palm-scan payment service, the electronic payment account aa may be displayed in the payment method interface based on the received first palm information, as shown in FIG. 10b.

In some embodiments, after the first palm information is received and the user identity is successfully matched, the second terminal device may search for and display the electronic payment account bound to the user. The electronic payment account is a digital wallet account bound by the user in a registration process to complete cardless payment, for example, an instant messaging APP payment account or another third-party payment platform account. The user needs to complete configuration of the electronic payment account in advance, and establish an association between the electronic payment account and the palm information of the user. By displaying the first electronic payment account, the second terminal device enables the user to observe a payment account to be used, thereby avoiding a misoperation or confusion of a plurality of accounts. In addition, the operation of displaying the first electronic payment account also enhances the transparency and user trust in the payment process.

In some embodiments, before the electronic payment accounts associated with the first palm information are displayed, the payment object may be verified first, to perform auxiliary verification to determine whether the payment object is an object that has activated the palm-scan payment service. The process of auxiliary verification is described below using an example in which the first palm information is associated with the first electronic payment account. After operation S901 is performed, the second terminal device may further display an auxiliary verification interface, and receive auxiliary verification information in a payment verification interface. Then, the second terminal device verifies the auxiliary verification information. If the verification succeeds, performing of the operation of displaying the configured first electronic payment account associated with the first palm information is triggered.

The request operation for the palm-scan payment service is received by the second terminal device. A display trigger condition of the auxiliary verification interface includes one or more of the following: the first palm information is collected by the second terminal device for the first time, and a frequency at which the first palm information is collected by the second terminal device does not reach a preset frequency. For example, when the payment object uses the palm-scan payment service for the first time, the second terminal device collects the first palm information for the first time. To enhance the security, the auxiliary verification interface may be displayed, and the auxiliary verification information is received through the auxiliary verification interface. The auxiliary verification information includes one or more of the following: an object identifier of the first object and an identity identifier of the first object. In some examples in view of FIG. 10c, the payment object uses the palm-scan payment service for the first time. After the palm-scan device receives the palm information, an auxiliary verification interface 1030 may be displayed. The auxiliary verification interface 1030 supports inputting verification information, such as the last four digits of a mobile phone number, associated with the palm-scan payment service. When verification on the last four digits succeeds, the first electronic payment account shown in FIG. 10b may be further displayed.

S903: Perform payment using the first electronic payment account. For example, a selected electronic payment account from the plurality of configured electronic payment accounts is determined by the processing circuitry based on a selection operation on the selection interface. Payment using the selected electronic payment account is performed.

The first electronic payment account stores a corresponding amount of digital asset. When payment is performed using the first electronic payment account, the corresponding amount of digital asset in the first electronic payment account may be transferred to an account of a transaction object according to the payment amount. The second terminal device may further output a payment result. The payment result is configured for indicating a payment success, and includes information such as a payment amount and a transaction object. If the digital asset stored in the electronic payment account and the digital asset stored in the account of the transaction object are of different types, a unit exchange rate between the two may further be displayed. FIG. 10d is a schematic diagram of outputting a payment result. When a particular electronic payment account is selected for payment, payment confirmation information may be first displayed. In response to a payment confirmation operation performed by the first object, for example, clicking a control 1040 of “pay now”, the payment result may be outputted in an independent interface 1041. The payment result is configured for indicating a payment success, and includes a payment amount and a payment object (A convenience store). Exchange rates between different digital assets are further displayed in the interface 1401.

In some embodiments, when the user confirms the payment, the second terminal device performs a deduction operation using the displayed first electronic payment account. The payment includes operations such as generating a transaction order, verifying an account balance, and invoking a payment interface to complete fund transfer. A payment process may be completed only using palm information of a user without relying on a physical card or mobile phone code scanning. Performing payment using the first electronic payment account not only improves the payment efficiency, but also reduces reliance of a user on a mobile device. This is especially applicable to a situation in which a mobile phone has insufficient power or cannot be used. In addition, since the payment process is performed based on the biometric features of the user identity rather than password or card information, information leakage and fraud risks are greatly reduced. In some embodiments, quick and secure identity verification may be realized by responding to the palm-scan payment request and receiving the first palm information. The first electronic payment account associated with the first palm information is displayed, to enable the user to observe a payment source and then uses the first electronic payment account to complete payment, thereby realizing a high-efficient and convenient cardless payment experience without relying on a mobile phone or a bank card, and improving the user satisfaction and the payment security.

In some embodiments, the first palm information is further associated with a second electronic payment account, and the second terminal device may further perform the following processing: displaying the configured second electronic payment account associated with the first palm information; performing payment using the second electronic payment account if the second electronic payment account is selected; and triggering, if the first electronic payment account is selected, to perform the operation of performing payment using the first electronic payment account. That is, when the first palm information is associated with a plurality of electronic payment accounts (such as the foregoing first electronic payment account and second electronic payment account), the first electronic payment account and the second electronic payment account may be displayed, and the first electronic payment account and the second electronic payment account may be arranged and displayed. Manners for arranging and displaying include, but are not limited to: arranging and displaying in descending order of set payment limits, arranging and displaying in various manners without a particular order, arranging and displaying in descending order of payment priorities of the electronic payment accounts, and arranging and displaying according to timestamps associated with the first palm information from latest to earliest. Since a plurality of electronic payment accounts are displayed, the payment object may select an electronic payment account for payment. Therefore, the second terminal device may perform payment using the selected electronic payment account in response to selection of the electronic payment account. For example, the second terminal device may perform payment using the second electronic payment account in response to selection of the second electronic payment account. A procedure of performing payment using the second electronic payment account is similar to a procedure of performing payment using the first electronic payment account. Details are not described herein again. When the first electronic payment account is selected, the second terminal device may trigger to perform operation S903 in response to the selection of the first electronic payment account.

According to one or more embodiments of this disclosure, the configured electronic payment account may be displayed by receiving the first palm information for the palm-scan payment service, and payment is performed using the configured electronic payment account. In this way, when an object consumes in an offline store, consumption payment may be completed without using a carry-on payment device (such as a mobile phone) or a physical bank card, thereby improving the payment efficiency of the object. If there are a plurality of configured electronic payment accounts, the object may further autonomously and flexibly select one of the electronic payment accounts for payment, thereby improving the payment convenience and flexibility.

Based on the descriptions of the foregoing embodiment, a mobile terminal (such as a mobile phone) may be adopted to configure a service online (including online palm enrollment), and a palm-scan device may be adopted to enable the service offline. In some examples, on a mobile phone, an object may scan a material code of a store using the mobile phone, enter an interaction interface of a first APP, then adjust a palm action or position according to an interaction prompt. A palm-scan system may perform living body detection on the palm of the object, and enroll a palm image (for example, a red, green, and blue (RGB) palm image). On a palm-scan device, an object that has completed online enrollment may be activated on a palm-scan device of an offline store within a corresponding time range or geographical range limit, and payment starts after the object clicks “confirm”. On a palm-scan service side, the palm image of the object may be replaced with two-factor palm information (that is, a palm print image and a palm vein image).

In an implementation, the second terminal device is a palm-scan device, and the palm-scan payment service is provided by the first APP. FIG. 10e is a schematic diagram of a use procedure of a palm-scan payment service. The second terminal device is a palm-scan device 1001. The palm-scan device 1001 may collect and provide first palm information (for example, left palm information) to a backend server (that is, a palm-scan APP backend 1002) of the first APP. The backend server may transmit an object identifier (for example, an object ID), a merchant identifier (for example, a merchant ID), and a dynamic token (that is, a dynamic token dynamically generated during each palm-scan payment) to an electronic payment account 1003. The dynamic token is associated with a static token (that is, a long-term object token). Based on the association, it may be determined whether the electronic payment account requested for use is an electronic payment account configured at a configuration stage. The static token is acquired after being associated with the electronic payment account in the configuration procedure of the palm-scan payment service. Under a payment rule allowed by the electronic payment account, after object palm scanning is successfully recognized, deduction may be performed by the electronic payment account party, thereby completing cardless payment. For example, after the electronic payment account verifies information indicated by the above object identifier, merchant identifier, or dynamic token, a payment code may be returned to the backend server, and the backend server returns the payment code to the second terminal device. The second terminal device is further connected to a merchant point-of-sale (POS) machine 1004 (that is, a payee device used by the merchant for non-cash settlement). Therefore, the payment code may be transmitted to the merchant POS machine, so that the merchant POS machine may initiate an order request to the electronic payment account through the payment code, that is, apply to transfer out a corresponding amount of digital asset. The electronic payment account may transfer, based on recognition of the payment code, the corresponding amount of digital asset to the merchant account through the merchant POS machine.

In some embodiments, the palm-scan payment service is provided by the first APP, the request operation is received by the second terminal device, and the second terminal device displays the configured first electronic payment account associated with the first palm information. As a non-limiting example, a technical procedure may include the following operations. First, retrieval is performed from a first feature library based on the first palm information. Then, if the target palm information matching the first palm information is retrieved from the first feature library, a recognition result is determined based on an object associated with target palm information. Finally, identity verification is performed on the first object based on the recognition result, and when the identity verification succeeds, at least one configured electronic payment account associated with the first palm information is queried.

In some examples, when target palm information matching the first palm information is retrievable from a first feature library, a recognition result based on an object associated with the target palm information is determined. In some examples, the first feature library is configured to store at least one group of palm information collected by the terminal device, each group of the at least one group of palm information including a palm print image and a palm vein image, and each group of the at least one group of palm information being associated with a respective object. In some examples, identity verification on the associated object is performed based on the recognition result. In some examples, the plurality of configured electronic payment accounts associated with the first palm information is queried when the identity verification on the associated object is successful.

In some embodiments, when retrieval is performed from the first feature library based on the first palm information, the second terminal device is a terminal device supporting palm print recognition and palm vein recognition, for example, a palm-scan device. The first feature library is configured for storing at least one group of palm information collected by the second terminal device. Each group of palm information includes a palm print image and a palm vein image. Each group of palm information is associated with one object. Since the second terminal device may be deployed in an offline store, the first feature library may alternatively be referred to as an offline feature library. The first palm information may include one or two of a palm print image and a palm vein image. Using the first palm information as a retrieval basis, the second terminal device may first retrieve, in the first feature library, whether one or more groups of palm information matching the first palm information exist. The matching herein may refer to a similarity between the first palm information and the palm information in the first feature library. For example, if the first palm information includes a palm print image, a group of palm information having the maximum similarity with the palm print image may be retrieved from the first feature library as matched target palm information.

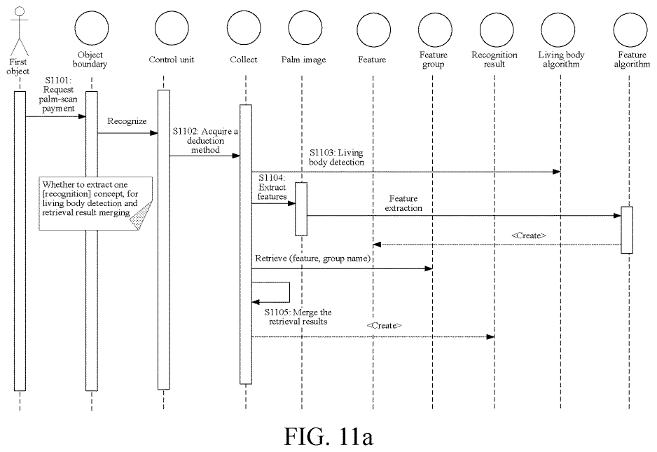

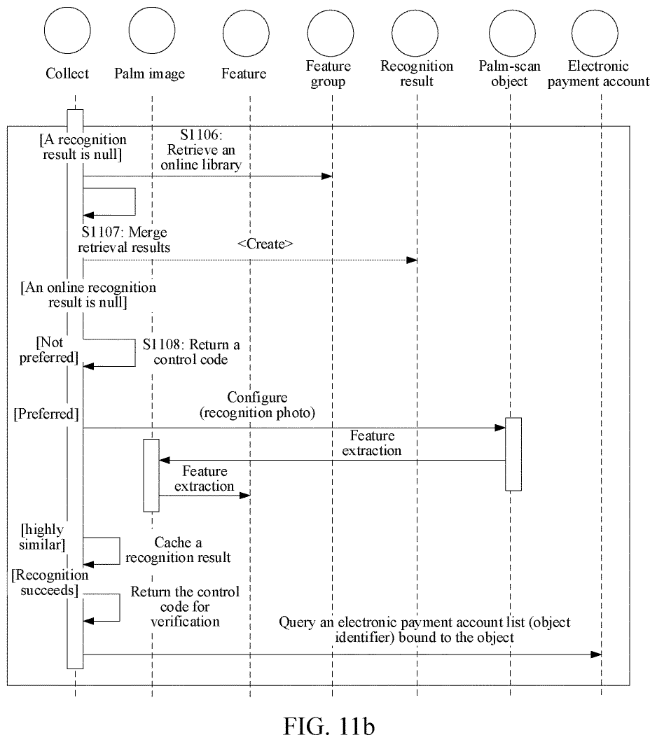

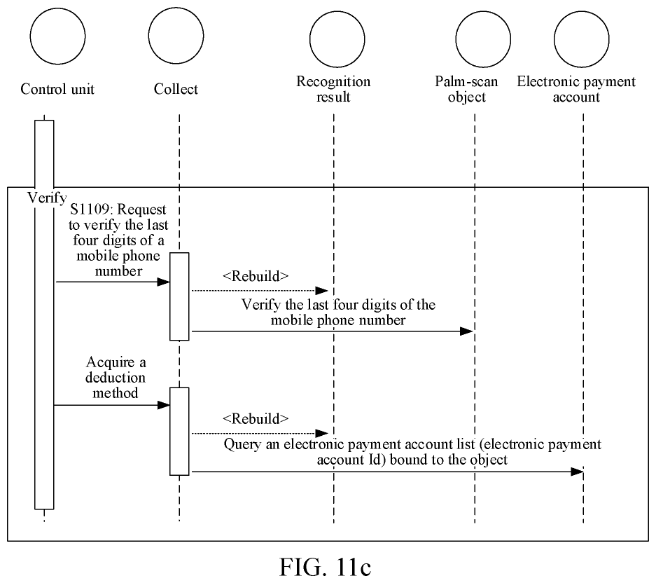

In an implementation, in a palm-scan payment scene, when the palm information of the first object is received, living body detection may be first performed on a palm, a palm image is collected when the living body detection succeeds, and feature extraction is performed on the palm image. After the first palm information is obtained, retrieval is performed from the first feature library. FIG. 11a is a flowchart of offline palm-scan payment. In operation S1101, a first object requests palm-scan payment, and recognition may be performed by an object boundary. Herein, the object boundary may determine whether to extract one recognition, including living body detection and retrieval result merging. Then, the palm-scan payment service is invoked to acquire a payment method (that is, acquire a deduction method in operation S1102), thereby displaying the at least one configured electronic payment account. During collection, living body detection may be performed according to a living body algorithm in operation S1103, so that a palm image is collected when the living body detection succeeds. In addition, features are extracted according to a feature algorithm in operation S1104. The first feature library may be a feature group. Each group of features is a group of palm information that may have a corresponding group name, so that during retrieval, retrieval may be performed according to the feature and the group name. When a plurality of groups of similar features are retrieved, retrieval results may further be merged in operation S1105. For example, a proportion of an object A associated with the retrieved palm information is the largest, thereby obtaining a recognition result that the first palm information belongs to the object A.

After retrieval is performed from the first feature library based on the first palm information, if the target palm information matching the first palm information is retrieved from the first feature library, the recognition result is determined based on the object associated with the target palm information. In at least one example, the similarity between the target palm information and the first palm information is greater than a preset similarity (for example, 96%). If the first palm information is the palm information of the first object, the target palm information is retrieved from the first feature library, indicating that the second terminal device has also collected the palm information of the first object. Since each group of palm information is associated with one object, the object associated with the target palm information may be determined as the recognition result.

In some embodiments, if any group of palm information matching the first palm information is not retrieved from the first feature library, retrieval is performed from the second feature library. The second feature library is configured for storing at least one piece of palm information collected by a first terminal device. The first terminal device is configured to receive a configuration operation for the palm-scan payment service. Each piece of palm information includes a palm print image, and is associated with one object. The first terminal device is a terminal device supporting palm print recognition, such as a smartphone. The first terminal device does not need to be fixed to an offline store. Instead, it is a carry-on mobile terminal device, and the palm information of the object may be collected anytime and anywhere. Therefore, the second feature library may alternatively be referred to as an online feature library.

In some examples, when the target palm information matching the first palm information is not retrievable from the first feature library, whether the target palm information is retrievable from a second feature library is determined. In some examples, the second feature library is configured to store at least one piece of palm information collected by another terminal device that is configured to receive a configuration operation for the palm-scan payment service, and each piece of the at least one piece of palm information including a palm print image associated with a respective object. In some examples, when the target palm information matching the first palm information is retrievable from the second feature library, the recognition result is determined based on the object associated with the target palm information. In some examples, when the target palm information matching the first palm information is not retrievable from the second feature library, a configuration request for the palm-scan payment service is generated.

In some embodiments, based on the retrieval result in the second feature library, the second terminal device may execute content described in the following two cases.

Case 1: If the target palm information matching the first palm information is retrieved from the second feature library, the recognition result is determined based on the object associated with the target palm information. That is, if the target palm information is not retrieved from the first feature library but is retrieved from the second feature library, the object associated with the target palm information can still be adopted to determine the recognition result. Since the palm information stored in the first feature library is different from that stored in the second feature library, the palm information stored in the second feature library includes a palm print image. If the first palm information includes the palm print image, the target palm information retrieved from the second feature library includes the palm print image matching the first palm information.

Case 2: If the target palm information matching the first palm information is not retrieved from the second feature library, a configuration request for the palm-scan payment service is generated. In at least one example, if the retrieval result obtained by retrieval from the second feature library is null, the second feature library does not have the target palm information matching the first palm information, so that the second terminal device may generate the configuration request for the palm-scan payment service, re-collect the first palm information for the palm-scan payment service, and repeatedly perform the foregoing operations.

After the recognition result is determined based on the object associated with the target palm information, identity verification is performed on the first object based on the recognition result, and when the identity verification succeeds, at least one configured electronic payment account associated with the first palm information is queried. In at least one example, the first palm information is the palm information of the first object, and the recognition result includes the object associated with the target palm information. The second terminal device may receive a returned control code (for example, the last four digits of a to-be-inputted mobile phone number) for verification, for example, verify the last four digits of the mobile phone number. If the last four digits of a mobile phone number inputted by the first object are the same as the last four digits of a mobile phone number bound to the object associated with the target palm information, the object is indeed the first object, so that a configured electronic payment account list of the first object may be queried based on an object identifier (for example, a user ID) of the first object in the first APP, thereby displaying the at least one configured electronic payment account.

FIG. 11b is a schematic flowchart of retrieval and recognition. When an offline recognition result is null, an online library may be retrieved in operation S1106, and retrieval results are merged in operation S1107, to obtain a recognition result. If an online recognition result is null, neither the first feature library nor the second feature library stores any palm information of the first object. Therefore, in an implementation, a palm-scan object may be requested to activate a recognition photo, that is, collect the palm information of the palm-scan object. In another implementation, a control code may be returned in operation S1108, so that the second terminal device is verified through the control code. For example, the palm-scan object is required to fill in the last four digits of a mobile phone number. When highly similar palm information is retrieved from the second feature library, the recognition result may be cached, so that when the first palm information is used next time, the cached recognition result may be directly used without retrieval from the feature library. When there is a recognition result, to enhance security, the control code may be returned for verification, and after the recognition succeeds, the electronic payment account associated with the first object is queried. A procedure for returning a control code for verification may refer to a detailed procedure shown in FIG. 11c. During the palm-scan payment service, verification of the last four digits of a mobile phone number may be requested in operation S1109. The second terminal device may receive and verify the last four digits of the mobile phone number inputted by the palm-scan object. After the verification succeeds, a payment method is acquired, and a recognition result is updated. A configured electronic payment account list may be queried based on the recognition result. The electronic payment account list includes an account ID.

One or more embodiments of this disclosure may be implemented in conjunction with a cardless payment solution enabling online palm enrollment and offline palm-scan payment jointly launched by a palm-scan technology provider, a payment mechanism providing an electronic payment account, and a merchant. In addition, in some embodiments, the existing acquiring-merchant network of the electronic payment account may be leveraged, without individually expanding merchant acquiring. The palm-scan payment service is provided by a first APP (an APP or a mini program), and the object may register and log in to an account of the first APP through a mobile phone. Palm enrollment may be completed in the first APP of the mobile phone, and an electronic payment account of the object may be bound. When the object goes to a merchant having a palm-scan device disposed offline, palm-scan payment may be used, and a digital asset in the bound electronic payment account is deducted. Thus, cardless payment may be completed through palm scanning without binding a bank card. After performing offline palm-scan payment, the object may further manage the palm and payment on an online mobile phone, for example, re-enroll a palm, manage a payment limit, and cancel and log out of an account.

According to one or more embodiments, a palm-scan payment service mentioned in the service processing method may be used in various payment scenes, including but not limited to: a payment scene of offline shopping, a payment scene of online shopping, and other payment scenes. For example, in a payment scene of offline shopping, after a customer purchases goods and a merchant completes the settlement, a to-be-paid order is generated. A palm-scan device of an offline store may collect palm information of the customer, and at least one electronic payment account configured for the palm-scan payment service is further displayed according to a comparison result between the collected palm information and palm features stored in a feature library. Based on selection of an electronic payment account, the order may be paid using the selected electronic payment account. In this way, the electronic payment account can be flexibly selected, and when a limit of an electronic payment account is insufficient, payment may further be performed through another electronic payment account, thereby improving the payment convenience.

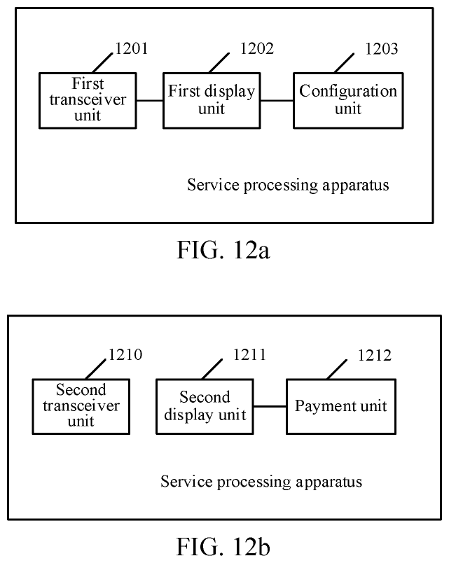

FIG. 12a is a schematic structural diagram of a service processing apparatus according to an embodiment of this disclosure. The service processing apparatus may be provided in the first terminal device provided in this disclosure. The service processing apparatus shown in FIG. 12a may be a computer program (including program code) running in the first terminal device. The service processing apparatus may be configured to perform some or all of the operations in the method embodiments shown in FIG. 2, FIG. 4, and FIG. 6. Referring to FIG. 12a, the service processing apparatus may include the following units: a first transceiver unit 1201, configured to receive, in response to a configuration operation of a first object for a palm-scan payment service, first palm information for the palm-scan payment service; a first display unit 1202, configured to display at least one electronic payment account of the first object; and a configuration unit 1203, configured to configure, in response to a selection operation on the at least one electronic payment account, a selected first electronic payment account as an electronic payment account associated with the first palm information, when the palm-scan payment service based on the first palm information is used, a configured first electronic payment account associated with the first palm information being adopted for payment.

In some embodiments, an owner of each electronic payment account is the first object. The first display unit 1202 is further configured to: acquire an object identifier of the first object, and display at least one electronic payment account corresponding to the object identifier of the first object; or receive at least one piece of account information inputted by the first object, and display an electronic payment account indicated by each piece of account information.

In some embodiments, the configuration unit 1203 is further configured to: display an identity verification interface in response to the selection operation on the at least one electronic payment account; receive, in the identity verification interface, identity verification information corresponding to the selected first electronic payment account, and verify the identity verification information; and configure, in response to successful verification of the identity verification information, the selected first electronic payment account as the electronic payment account associated with the first palm information, the identity verification information corresponding to the selected first electronic payment account including at least one of the following: a payment password of the first electronic payment account, an account identifier of the first electronic payment account, an object identifier corresponding to the first electronic payment account, and biometric feature information associated with the first electronic payment account.

In some embodiments, the first display unit 1202 is further configured to: output account authorization prompt information in response to the selection operation on the at least one electronic payment account, the account authorization prompt information being configured for prompting authorization of the selected first electronic payment account; and display the identity verification interface in response to an authorization operation performed on the first electronic payment account.

In some embodiments, the first transceiver unit 1201 is further configured to: receive, in response to a palm addition operation of the first object for the palm-scan payment service, second palm information added for the palm-scan payment service. The configuration unit 1203 is further configured to: configure the first electronic payment account as an electronic payment account associated with the second palm information, the second palm information and the first palm information being different palm information of a same object; or the second palm information and the first palm information being palm information of different objects.

In some embodiments, the first transceiver unit 1201 is further configured to: receive, in response to an account addition operation of the first object for the palm-scan payment service, a second electronic payment account added for the palm-scan payment service. The configuration unit 1203 is further configured to: configure the second electronic payment account as the electronic payment account associated with the first palm information, an owner of the second electronic payment account being the first object, and the first electronic payment account being different from the second electronic payment account.

In some embodiments, the palm-scan payment service supports configuring N pieces of palm information, any one of the N pieces of palm information is represented as palm information n, and n and N are positive integers. The apparatus further includes a management unit, configured to manage the N pieces of palm information. Management of the palm information n includes at least one of the following: setting a palm identifier for the palm information n, displaying the palm information n, deleting the palm information n, and modifying the palm information n; and the palm information n including one or two of a palm print image and a palm vein image.

In some embodiments, the palm-scan payment service supports configuring M electronic payment accounts associated with the first palm information for payment; any one of the M electronic payment accounts is represented as an electronic payment account m, m and M are both positive integers, and m is less than or equal to M. The management unit is further configured to manage the M electronic payment accounts. Management of the electronic payment account m includes at least one of the following: setting an account identifier for the electronic payment account m, displaying the electronic payment account m, deleting the electronic payment account m, setting a payment priority of the electronic payment account m, setting a payment limit of the electronic payment account m, and setting payment permission of the electronic payment account m.

In some embodiments, the palm-scan payment service is configured with the M electronic payment accounts associated with the first palm information for payment; any one of the M electronic payment accounts is represented as the electronic payment account m. The first display unit 1202 is further configured to: display, in response to a bill viewing operation on the electronic payment account m, a bill for the electronic payment account m, the bill for the electronic payment account m being configured for recording at least one transaction involved in payment using the electronic payment account m in the palm-scan payment service.

In some embodiments, setting content of the payment limit includes at least one of the following: a daily payment limit, a weekly payment limit, a monthly payment limit, and an annual payment limit; and the payment permission includes at least one of the following: an allowed time period and at least one allowed object.

In some embodiments, the apparatus further includes a query unit, configured to: query, in response to the configuration operation of the first object for the palm-scan payment service, configuration information of the first object for the palm-scan payment service, the configuration information being configured for indicating a configuration status of the first object for the palm-scan payment service; and a first processing unit, configured to: perform information configuration on the first object based on the configuration status indicated by the configuration information.

In some embodiments, the palm-scan payment service is provided by a first APP. The first processing unit is further configured to: associate, when it is confirmed that the object identifier of the first object is authorized, an account of the first object in the first APP with the object identifier of the first object in response to the configuration status indicated by the configuration information being a first configuration status, the first configuration status being that the account of the first object in the first APP is not associated with the object identifier of the first object.

In some embodiments, the first processing unit is further configured to: collect a palm image of the first object in response to the configuration status indicated by the configuration information being a second configuration status, the second configuration status being that the first object does not enroll the first palm information for the palm-scan payment service; and perform feature extraction on the palm image to obtain the first palm information.

In some embodiments, the first processing unit is further configured to: query enabling permission of the electronic payment account of the first object in response to the configuration status indicated by the configuration information being a third configuration status, the third configuration status being that the first palm information is not associated with any electronic payment account; and acquire the at least one electronic payment account of the first object when the enabling permission indicates that the electronic payment account is enabled.

FIG. 12b is a schematic structural diagram of another service processing apparatus according to an embodiment of this disclosure. The service processing apparatus may be provided in the second terminal device provided in this disclosure. The service processing apparatus shown in FIG. 12a may be a computer program (including program code) running in the second terminal device. The service processing apparatus may be configured to perform some or all of the operations in the method embodiment shown in FIG. 9. Referring to FIG. 12b, the service processing apparatus may include the following units: a second transceiver unit 1210, configured to receive, in response to a request operation for a palm-scan payment service, first palm information for the palm-scan payment service; a second display unit 1211, configured to display a configured first electronic payment account associated with the first palm information; and a payment unit 1212, configured to perform payment using the first electronic payment account.

In some embodiments, the first palm information is further associated with a second electronic payment account. The second display unit 1211 is further configured to: display a configured second electronic payment account associated with the first palm information; perform payment using the second electronic payment account in response to selecting the second electronic payment account; and trigger, in response to selecting the first electronic payment account, to perform the operation of performing payment using the first electronic payment account.

In some embodiments, the palm-scan payment service is provided by a first APP, and the request operation is received by the second terminal device. The apparatus further includes: a second processing unit, configured to: determine, in response to retrieving target palm information matching the first palm information from a first feature library, a recognition result based on an object associated with the target palm information, the first feature library being configured for storing at least one group of palm information collected by the second terminal device; each group of palm information including a palm print image and a palm vein image; and each group of palm information being associated with one object; perform identity verification on the first object based on the recognition result; and query, in response to a verification result of the identity verification being that the verification succeeds, at least one configured electronic payment account associated with the first palm information.

In some embodiments, the second processing unit is further configured to: retrieve, in response to not retrieving palm information matching the first palm information from the first feature library, the palm information from a second feature library, the second feature library being configured for storing at least one piece of palm information collected by a first terminal device; the first terminal device being configured to receive a configuration operation for the palm-scan payment service; and each piece of palm information including a palm print image, and being associated with one object; determine, in response to retrieving the target palm information matching the first palm information from the second feature library, the recognition result based on the object associated with the target palm information; and generate, in response to failing to retrieve the target palm information matching the first palm information from the second feature library, a configuration request for the palm-scan payment service.

In one or more examples, certain functions of the units of the service processing apparatus described in this disclosure may be implemented according to the method in the foregoing method embodiment. As a non-limiting example, an implementation process may refer to related descriptions in the foregoing method embodiment. Details are not described herein again. In addition, the description of beneficial effects of the same method is not described herein again.

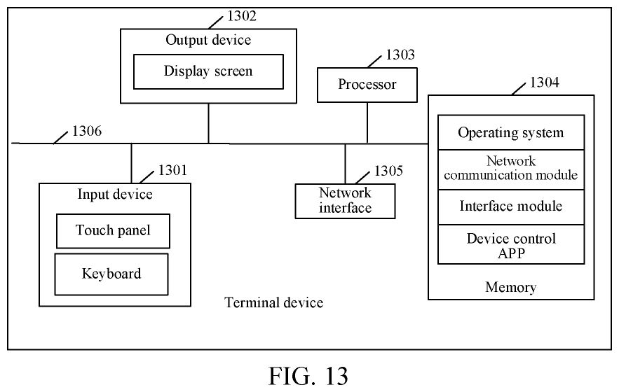

FIG. 13 is a schematic structural diagram of a terminal device according to an embodiment of this disclosure. The terminal device may be implemented as the foregoing first terminal device or the foregoing second terminal device. As shown in FIG. 13, the terminal device may include an input device 1301, an output device 1302, processing circuitry (e.g., a processor 1303), a memory 1304 (e.g., including a non-transitory computer-readable storage medium), a network interface 1305, and at least one communication bus 1306. The processor 1303 may be a central processing unit (CPU). The processor may further include a hardware chip. The hardware chip may be an application-specific integrated circuit (ASIC), a programmable logic device (PLD), or the like. The PLD may be a field-programmable gate array (FPGA), a generic array logic (GAL), or the like.

In some embodiments, when the terminal device shown in FIG. 13 is the first terminal device, that is, the first terminal device 101a in the service processing system shown in FIG. 1, the processor 1303 may be configured to invoke the computer program in the memory 1304 (e.g., stored in the non-transitory computer-readable storage medium) to perform the following operations: receiving, in response to a configuration operation of a first object for a palm-scan payment service, first palm information for the palm-scan payment service; displaying at least one electronic payment account of the first object; and configuring, in response to a selection operation on the at least one electronic payment account, a selected first electronic payment account as an electronic payment account associated with the first palm information, when the palm-scan payment service based on the first palm information is used, a configured first electronic payment account associated with the first palm information being adopted for payment.

In some embodiments, when the terminal device shown in FIG. 13 is a second terminal device, that is, the second terminal device 101b in the service processing system shown in FIG. 1, the processor 1303 may be configured to invoke the computer program in the memory 1304 (e.g., stored in the non-transitory computer-readable storage medium) to perform the following operations: receiving, in response to a request operation for a palm-scan payment service, first palm information for the palm-scan payment service; displaying a configured first electronic payment account associated with the first palm information; and performing payment using the first electronic payment account.

The terminal device described in this disclosure may perform the service processing method based on one or more embodiments in the foregoing description, or may be configured as the service processing apparatus based on one or more embodiments in the foregoing description. Details are not described herein again. In addition, the description of beneficial effects are not described herein again.

In addition, the embodiments of this disclosure further provide a non-transitory computer-readable storage medium, having a computer program stored therein. The computer program includes program instructions. When executing the foregoing program instructions, the processing circuitry (e.g., a processor) can perform the method based on one or more embodiments corresponding to FIG. 2, FIG. 4, FIG. 6, and FIG. 9. Therefore, details are not described herein again.

According to an aspect of this disclosure, a computer program product is provided, including a computer program. The computer program is stored in the non-transitory computer-readable storage medium. Processing circuitry (e.g., a processor) of a terminal device reads the computer program from the non-transitory computer-readable storage medium. When executing the computer program, the processor causes the terminal device to perform the method based on one or more embodiments corresponding to FIG. 2, FIG. 4, FIG. 6, and FIG. 9. Therefore, details are not described herein again.

A person skilled in the art may understand that all or some of the procedures in the methods of the foregoing embodiments may be accomplished by instructing the relevant hardware through the computer program. The computer program may be stored on a non-transitory computer-readable storage medium and may include the procedures of the foregoing method embodiments when executed. The non-transitory computer-readable storage medium may be a magnetic disc, an optical disc, a read-only memory (ROM), a random access memory (RAM), or the like.

The foregoing disclosure includes non-limiting embodiments of this disclosure, and is not intended to limit the scope of this disclosure. Any equivalent variations made based on the examples of this disclosure shall fall within the scope of this disclosure.

What is claimed is:

1. A service processing method, comprising:
receiving, by processing circuitry of a terminal device, first palm information for a palm-scan payment service based on a configuration operation of an object for the palm-scan payment service;
displaying, in a selection interface, account identification information of at least one electronic payment account associated with the object;
determining a first selected electronic payment account from the at least one electronic payment account based on a selection operation on the selection interface; and
configuring, by the processing circuitry, the first selected electronic payment account as a first configured electronic payment account associated with the first palm information for the palm-scan payment service, the palm-scan payment service being configured to process payment using the first configured electronic payment account when the palm-scan payment service is requested based on the first palm information.

2. The method according to claim 1, further comprising obtaining the account identification information from:
first account information of first one or more accounts registered as being associated with an object identifier of the first object; or
second account information of second one or more accounts received by the terminal device based on a user input operation.

3. The method according to claim 1, wherein
the determining the first selected electronic payment account includes:
displaying an identity verification interface based on the selection operation on the selection interface;
receiving, in the identity verification interface, identity verification information corresponding to the first selected electronic payment account; and
performing verification of the identity verification information, and
the configuring the first selected electronic payment account as the first configured electronic payment account is based on successful verification of the identity verification information.

4. The method according to claim 3, wherein the displaying the identity verification interface comprises:
outputting account authorization prompt information based on the selection operation on the selection interface, the account authorization prompt information prompting authorization of the first selected electronic payment account; and
displaying the identity verification interface based on an authorization operation performed on the first selected electronic payment account.

5. The method according to claim 1, further comprising:
receiving, based on a palm addition operation for the palm-scan payment service, second palm information added for the palm-scan payment service; and
configuring the first selected electronic payment account as a configured electronic payment account associated with the second palm information for the palm-scan payment service.

6. The method according to claim 1, further comprising:
receiving, based on an account addition operation of the object for the palm-scan payment service, a second selected electronic payment account for the palm-scan payment service and that is different from the first selected electronic payment account; and
configuring the second selected electronic payment account as a second configured electronic payment account associated with the first palm information for the palm-scan payment service.

7. The method according to claim 1, wherein
the palm-scan payment service supports configuring N pieces of palm information, any one of the N pieces of palm information being represented as palm information n, N being a positive integer, and n being a positive integer ranging from 1 to N,
the palm information n includes at least one of a palm print image or a palm vein image, and
the method further includes managing the palm information n, including at least one of:
setting a palm identifier for the palm information n,
displaying the palm information n,
deleting the palm information n, or
modifying the palm information n.

8. The method according to claim 1, wherein
the palm-scan payment service supports configuring M electronic payment accounts associated with the palm information for payment, any one of the M electronic payment accounts being represented as an electronic payment account m, M being a positive integer, and m being a positive integer ranging from 1 to M, and
the method further includes managing the electronic payment account m, including at least one of:
setting an account identifier for the electronic payment account m,
displaying the electronic payment account m,
deleting the electronic payment account m, setting a payment priority of the electronic payment account m,
setting a payment limit of the electronic payment account m, or
setting payment permission of the electronic payment account m.

9. The method according to claim 8, further comprising:
displaying, based on a bill viewing operation on the electronic payment account m, a bill for the electronic payment account m recording at least one transaction involved in payment using the electronic payment account m in the palm-scan payment service.

10. The method according to claim 8, wherein
the payment limit is associated with a predefined time period, and
the payment permission includes at least one of: an allowed time period and at least one allowed object.

11. The method according to claim 1, further comprising:
querying, based on the configuration operation of the object for the palm-scan payment service, configuration information of the object for the palm-scan payment service, the configuration information indicating a configuration status of the object for the palm-scan payment service; and
configuring the palm-scan payment service for the object based on the configuration status indicated by the configuration information.

12. The method according to claim 11, wherein
the palm-scan payment service is provided by an application (APP), and
the configuring the palm-scan payment service includes:
associating an account of the object in the APP with an object identifier of the object when usage of the object identifier in the palm-scan payment service is authorized and the configuration status indicates that the account of the object in the APP is not associated with the object identifier of the object.

13. The method according to claim 11, wherein
the configuring the palm-scan payment service includes:
collecting a palm image of the object when the configuration status indicates that the object does not enroll the palm information for the palm-scan payment service; and
performing feature extraction on the palm image to obtain the first palm information.

14. The method according to claim 11, wherein
the configuring the palm-scan payment service includes:
querying enabling permission of one or more electronic payment accounts of the object when the configuration status indicates that the first palm information is not associated with any electronic payment account; and
acquiring the account identification information of the at least one electronic payment account of the object based on a subset of the one or more electronic payment accounts that has the enabling permission.

15. A service processing method, comprising:
receiving, by processing circuitry of a terminal device based on a request operation for a palm-scan payment service, first palm information for the palm-scan payment service;
displaying, in a selection interface, account identification information of a plurality of configured electronic payment accounts associated with the first palm information;
determining, by the processing circuitry, a selected electronic payment account from the plurality of configured electronic payment accounts based on a selection operation on the selection interface; and
performing payment using the selected electronic payment account.

16. The method according to claim 15, wherein
the palm-scan payment service is provided by an application (APP),
the request operation is received by the terminal device, and
the method further includes:
determining, when target palm information matching the first palm information is retrievable from a first feature library, a recognition result based on an object associated with the target palm information, the first feature library being configured to store at least one group of palm information collected by the terminal device, each group of the at least one group of palm information including a palm print image and a palm vein image, and each group of the at least one group of palm information being associated with a respective object;
performing identity verification on the associated object based on the recognition result; and
querying the plurality of configured electronic payment accounts associated with the first palm information when the identity verification on the associated object is successful.

17. The method according to claim 16, further comprising:
determining, when the target palm information matching the first palm information is not retrievable from the first feature library, whether the target palm information is retrievable from a second feature library, the second feature library being configured to store at least one piece of palm information collected by another terminal device that is configured to receive a configuration operation for the palm-scan payment service, and each piece of the at least one piece of palm information including a palm print image associated with a respective object;
determining, when the target palm information matching the first palm information is retrievable from the second feature library, the recognition result based on the object associated with the target palm information; and
generating, when the target palm information matching the first palm information is not retrievable from the second feature library, a configuration request for the palm-scan payment service.

18. A terminal device, comprising:
processing circuitry configured to:
receive first palm information for a palm-scan payment service based on a configuration operation of an object for the palm-scan payment service;
display, in a selection interface, account identification information of at least one electronic payment account associated with the object;
determine a first selected electronic payment account from the at least one electronic payment account based on a selection operation on the selection interface; and
configure the first selected electronic payment account as a first configured electronic payment account associated with the first palm information for the palm-scan payment service, the palm-scan payment service being configured to process payment using the first configured electronic payment account when the palm-scan payment service is requested based on the first palm information.

19. The terminal device according to claim 18, wherein the processing circuitry is configured to obtain the account identification information from:
first account information of first one or more accounts registered as being associated with an object identifier of the first object; or
second account information of second one or more accounts received by the terminal device based on a user input operation.

20. The terminal device according to claim 18, wherein the processing circuitry is configured to:
receive, based on a palm addition operation for the palm-scan payment service, second palm information added for the palm-scan payment service; and
configure the first selected electronic payment account as a configured electronic payment account associated with the second palm information for the palm-scan payment service,
the second palm information and the first palm information being different palm information of the object or different objects.
